(19) United States
(12) Patent Application Publication
(10) Pub. No.: US 2026/0066756 A1
(43) Pub. Date: Mar. 5, 2026

(54) AXIAL FLUX SWITCHED RELUCTANCE MOTOR AND GENERATOR, AND RELATED SYSTEMS AND METHODS

(71) Applicant: Anthropocene Institute LLC, Palo Alto, CA (US)

(72) Inventors: Scott BARTLETT, San Pablo, CA (US); Martin PENA, Pinole, CA (US); Carl PAGE, Palo Alto, CA (US)

(73) Assignee: Anthropocene Institute LLC, Palo Alto, CA (US)

(21) Appl. No.: 18/820,963

(22) Filed: Aug. 30, 2024

(51) Int. Cl. H02K 19/10; H02K 1/14; H02K 1/24; H02K 3/52; H02K 11/01

(52) U.S. Cl. CPC H02K 19/103; H02K 1/146; H02K 1/246; H02K 3/522; H02K 11/0141; H02K 2203/12

(57) ABSTRACT

An axial flux switched reluctance motor and/or generator, and controls are provided. It includes a stator, which includes a front surface and a rear surface, and sidewalls that extend from the front surface to the rear surface. The stator includes salient stator poles positioned on the front surface. Each one of the salient stator poles including: a bobbin protruding out from the front surface in a direction along an axis of the bobbin that is perpendicular to the front surface; the bobbin comprising a bobbin front surface that is parallel to the front surface of the stator; and a coil of electrically insulated wire wound around the bobbin. A rotor includes a front rotor surface and an opposite facing rear rotor surface, and further includes a plurality of rotor poles. The rotor is affixed to a shaft and rotates about an axis of rotation that is aligned with the shaft.

### TECHNICAL FIELD

The disclosed exemplary embodiments relate to axial flux switched reluctance electric motors or generators, or both.

### BACKGROUND

Numerous types of electric motors and generators are currently available for use in many commercial applications including electric vehicles (EVs), blowers, tools, pumps, fans, mixers, food processors, robotics, and power generators, among other applications. Motors typically include a stator that is fixed and rotor that rotates in relation to the stator. The rotor is connected to a drive shaft that drives operations associated with particular applications.

In direct current (DC) motors, a DC current is applied to windings of the rotor to generate an electromagnetic (EM) field. While the rotor is rotated, the current applied to the rotor is commutated via mechanical brushes or via electronic control in a brushless configuration. The stator of a DC motor typically includes magnets that provide magnetic fields that interact with the EM field generated by the rotor to affect rotation of the rotor. The stator magnets are typically made of rare Earth metals, such as neodymium and dysprosium that provide high-density magnetic fields to facilitate relatively high torque for a DC motor.

In alternating current (AC) motors, such as induction motors and reluctance motors, an alternating current (AC) or sinusoidal signal is applied to the stator to generate a rotating EM field that drives rotation of an adjacent rotor. A three-phase induction motor typically has a stator with three pole pairs (i.e., six stator poles), where each pole pair includes series-connected windings that carry one of the three phases of an electrical voltage and current applied to the stator of the induction motor. Each phase of the current is offset by 120 degrees while each corresponding pole pair is physically offset by 120 degrees from each other. This physical and electrical configuration provides a rotating EM field that interacts with the rotor to drive rotation of the rotor assembly. The rotor may have a squirrel-cage configuration that enables current flow along the conduits of the squirrel-cage, resulting in the generation of an EM field that interacts with the EM field generated by the stator to, thereby, facilitate rotation of the rotor. The speed of rotation of the rotor may be controlled using various techniques such as varying the frequency of the current applied to each phase winding or varying the voltage, among other techniques.

A single-phase induction motor can be referred to as a reluctance motor. Rotation of a reluctance motor is based on the principle that rotor and stator poles will move to a position where the lines of an EM field have lower or lowest reluctance (i.e., lower EM field resistance). A single-phase reluctance motor is not self-starting and therefore uses a secondary phase at startup to create a rotating EM field until a set speed of rotation is reached where a centrifugal switch removes the secondary phase windings from the circuit. A capacitor may be used in the secondary windings to affect a phase shift of the secondary windings to enable a rotating field during initial startup. Another type of reluctance motor is a three-phase switched reluctance motor (SRM). A SRM is self-starting because it includes three phases that are offset by 120 degrees electronically and three pole pairs that provide a physical 120 degrees offset from each other to facilitate rotation of a rotor assembly subject to the EM field generated by the stator assembly. A SRM uses an electronic controller that controls excitation of each of the phase windings to generate a rotating EM field.

Existing DC motors or generators for EVs or other applications typically use rare Earth metals that can adversely affect the environment and are becoming less available due to demand. Induction and reluctance motors can provide an alternative to DC motors to reduce the need for rare Earth metals, but typically have lower performance capabilities compared to DC motors. Accordingly, there is a need to implement motors that eliminate or reduce the use of rare Earth metals, while providing sufficient performance capabilities with respect to DC motors or AC motors using rare Earth metals.

### SUMMARY

The following summary is intended to introduce the reader to various aspects of the detailed description, but not to define or delimit any invention.

The application, in various implementations, addresses deficiencies associated with existing electric motor and generator implementations.

In at least a broad aspect, an axial flux switched reluctance motor is provided, that comprises: a stator comprising a front surface and an opposite facing rear surface, and a plurality of sidewalls that extend from the front surface to the rear surface. The stator further comprising a plurality of salient stator poles positioned on the front surface, and each one of the plurality of salient stator poles comprising: a bobbin protruding out from the front surface in a direction along an axis of the bobbin that is perpendicular to the front surface; the bobbin comprising a bobbin front surface that is substantially parallel to the front surface of the stator; and a coil of electrically insulated aluminum wire wound around the bobbin. The axial flux switched reluctance motor further comprises a rotor comprising a front rotor surface and an opposite facing rear rotor surface, and further comprising a plurality of rotor poles; the rotor affixed to a shaft and configured to rotate about an axis of rotation that is aligned with the shaft; and wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles. The axial flux switched reluctance motor operates with a temperature of the coil of at least 150 degrees Celsius and a shaft speed of over 5000 Rotations Per Minute (RPM).

In some cases, the coil of electrically insulated aluminum wire wound around the bobbin is encapsulated in an encapsulation compound that has an operating temperature of over 150 degrees Celsius. In some cases, the operating temperature of the encapsulation compound is over 200 degrees Celsius. In some cases, the operating temperature of the encapsulation compound is over 250 degrees Celsius.

In some cases, an input power of over 700 Watts is provided to the axial flux switched reluctance motor, and the shaft speed is at least 8000 RPM. In some cases, the axial flux switched reluctance motor sustains operating with the shaft speed of at least 8000 RPM for at least 30 minutes.

In some cases, an input voltage of 106 Volts, an input current of 6.7 Amps, and an input power of 711 Watts is provided to the axial flux switched reluctance motor; and the shaft speed is over 8100 RPM and the temperature of the coil is at least 180 degrees Celsius. In some cases, the temperature of the coil is at least 200 degrees Celsius. In some cases, the temperature of the coil is at least 210 degrees Celsius. In some cases, the axial flux switched reluctance motor sustains operating at over 8000 RPM and over 200 degrees Celsius for at least 30 minutes.

In some cases, an input voltage of over 59 Volts is provided to the axial flux switched reluctance motor.

In some cases, an input voltage of between 59 and 61 Volts is provided to the axial flux switched reluctance motor, and the axial flux switched reluctance motor operates at the shaft speed of over 5700 RPM. In some cases, the axial flux switched reluctance motor sustains operating at the shaft speed of over 5700 RPM for at least 30 minutes.

In some cases, the axial flux switched reluctance motor sustains operating at the shaft speed of over 5000 RPM for at least one hour. In some cases, the axial flux switched reluctance motor sustains operating at the shaft speed of over 5000 RPM for at least three hours. In some cases, the axial flux switched reluctance motor sustains operating at the shaft speed of over 6000 RPM for at least one hour. In some cases, the axial flux switched reluctance motor sustains operating at the shaft speed of over 6000 RPM for at least three hours. In some cases, the axial flux switched reluctance motor sustains operating at the shaft speed of over 8000 RPM for at least three hours.

In some cases, the axial flux switched reluctance motor further comprises a housing that includes an electromagnetic field (EMF) metal shield that encompasses the stator and the rotor, and the EMF metal shield defines therein a plurality of ventilation holes.

In at least another broad aspect, an axial flux switched reluctance motor is provided, comprising: a stator comprising a front surface and an opposite facing rear surface, and a plurality of sidewalls that extend from the front surface to the rear surface. The stator further comprising a plurality of salient stator poles positioned on the front surface, and each one of the plurality of salient stator poles comprising: a bobbin protruding out from the front surface in a direction along an axis of the bobbin that is perpendicular to the front surface; the bobbin comprising a bobbin front surface that is substantially parallel to the front surface of the stator; and a coil of electrically insulated aluminum wire wound around the bobbin. The axial flux switched reluctance motor further comprises: a rotor comprising a front rotor surface and an opposite facing rear rotor surface, and further comprising a plurality of rotor poles; the rotor affixed to a shaft and configured to rotate about an axis of rotation that is aligned with the shaft; and wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles. The axial flux switched reluctance motor further comprises: a housing that comprises a first major circular component and a second major circulator component, and the stator and the rotor are positioned between the first major circular component and the second major circular component, and the first major circular component and the second major circular component each comprise electromagnetic field (EMF) shielding metal that has defined therein a plurality of ventilation holes.

In some cases, the first major circular component and the second major circular component are each substantially parallel to a plane of rotation of the rotor.

In some cases, the housing further comprises an outer chassis that encapsulates the first major circular component, the second major circular component, the stator, and the rotor; the outer chassis defines therein a first plurality of holes on a first major section that is facing the first major circular component and the first plurality of holes are aligned with at least a subset of the plurality of ventilation holes defined in the first major circular component.

In some cases, the outer chassis defines therein a second plurality of holes on a second major section that is facing the second major circular component and the second plurality of holes are aligned with at least another subset of the ventilation holes defined in the second major circular component.

In some cases, the outer chassis is made from a different material than the EMF shielding metal. In some cases, the outer chassis is made of a polymer.

In some cases, the outer chassis comprises a plurality of components fixed together, including at least a first outer chassis component comprising the first major section and a second outer chassis component comprising the second major section.

In some cases, the axial flux switched reluctance motor further comprises a mounting bracket attached to the first major section or the second major section, or both, and the mounting bracket defining therein a bracket hole that is aligned with at least a subset of the plurality of ventilation holes defined in the first major circular component or at least a subset of the plurality of ventilation holes defined in the second major circular component.

In some cases, the housing further comprises a circumferential metal EMF shield that circumferentially extends around the rotor and the stator, and extends between the first major circular component and the second major circular component, wherein the circumferential metal EMF shield defines a plurality of ventilation holes.

In some cases, the housing further comprises an outer chassis, and the outer chassis comprises an outer circumferential portion that circumferentially extends around the circumferential metal shield; and, the outer circumferential portion defining therein a plurality of outer ventilation holes that are aligned with the plurality of ventilation holes defined in the circumferential metal EMF shield.

In some cases, the axial flux switched reluctance motor operates with a temperature of the coil of at least 150 degrees Celsius and a shaft speed of over 5000 Rotations Per Minute (RPM).

In some cases, an input power of over 700 Watts is provided to the axial flux switched reluctance motor, and the shaft speed is at least 8000 RPM.

In some cases, the temperature of the coil is over 180 degrees Celsius.

In at least another broad aspect, an axial flux switched reluctance motor, is provided, comprising: a stator comprising a front surface and an opposite facing rear surface, and a plurality of sidewalls that extend from the front surface to the rear surface. The stator further comprising a plurality of salient stator poles positioned on the front surface, each one of the plurality of salient stator poles comprising: a bobbin protruding out from the front surface in a direction along an axis of the bobbin that is perpendicular to the front surface; the bobbin comprising a bobbin front surface that is substantially parallel to the front surface of the stator; and a coil of electrically insulated aluminum wire wound around the bobbin. The axial flux switched reluctance motor further comprises: a rotor comprising a front rotor surface and an opposite facing rear rotor surface, and further comprising a plurality of rotor poles; the rotor affixed to a shaft and configured to rotate about an axis of rotation that is aligned with the shaft; and wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles. The axial flux switched reluctance motor further comprises a housing that comprises a first major circular component and a second major circulator component, and the stator and the rotor are positioned between the first major circular component and the second major circular component, and the first major circular component and the second major circular component each comprise electromagnetic field (EMF) shielding metal that has defined therein a plurality of ventilation holes. The first major circular component and the second major circular component are each substantially parallel to a plane of rotation of the rotor. The housing further comprises an outer chassis that encapsulates the first major circular component, the second major circular component, the stator, and the rotor. The outer chassis defines therein a first plurality of holes on a first major section that is facing the first major circular component and the first plurality of holes are aligned with at least a subset of the plurality of ventilation holes defined in the first major circular component. The housing further comprises a circumferential metal EMF shield that circumferentially extends around the rotor and the stator, and extends between the first major circular component and the second major circular component, wherein the circumferential metal EMF shield defines therein an additional plurality of ventilation holes. The outer chassis comprises an outer circumferential portion that circumferentially extends around the circumferential metal EMF shield, and, the outer circumferential portion defining therein a plurality of outer ventilation holes that are aligned with the plurality of additional ventilation holes defined in the circumferential metal EMF shield. The axial flux switched reluctance motor operates with a temperature of the coil of at least 150 degrees Celsius and a shaft speed of over 5000 Rotations Per Minute (RPM).

In some cases, this application describes exemplary systems, methods, and devices that implement reluctance motors capable of providing sufficient power and/or torque for a drive shaft to adequately operate within, for example, an electric vehicle (EV). The exemplary reluctance motor or generator systems, methods, and devices can provide implementations that do not use rare Earth metals while not sacrificing performance with respect to other motors using rare Earth metals, such as DC motors. Rare earth magnets and/or copper conductors can still be utilized to amplify the performance of the reluctance motors described herein if desired. However, the motors described leverage reluctance to generate torque or electrical power. Furthermore, inventive electromagnets are described that are suitable for integration into electric motors which have flux characteristics comparable to rare Earth magnets. In some implementations, a magnetic circuit that includes the electromagnets utilizes low cost, readily available steel alloys. The aforementioned components may be packaged in such a way to optimize the flux path for each phase, resulting in reduced power consumption and increased torque. In various implementations, the heat generation of the electric motor is significantly improved due to the geometric construction of the electromagnets and control of electrical excitation.

In some cases, a state machine (i.e., a motor and/or generator) includes a stator assembly arranged to generate a rotating electromagnetic field in response to a control signal. The state machine also includes a rotor assembly, positioned adjacent to the stator assembly, arranged to rotate in response to the rotating electromagnetic field. A first sensor is arranged to detect an angular position of the rotor assembly and output first sensor data based on the angular position of the rotor assembly. A controller is arranged to receive the first sensor data and adjust the control signal based on the angular position of the rotor assembly to adjust a torque associated with the rotor assembly when the state machine functions as a motor or to adjust a power output from the stator assembly when the state machine functions as a generator.

In some implementations, a second sensor is arranged to detect one or more state machine conditions such as, for example, a rotor assembly speed, stator current, stator voltage, and/or state machine temperature. The second sensor may output second sensor data corresponding to the one or more state machine conditions, where the controller is further arranged to receive the second sensor data and adjust the control signal based on the second sensor data.

In some cases, the control signal may include a pulse and/or square waveform. The controller may adjust the speed of rotation of the rotor assembly by adjusting a frequency associated with the control signal. The state machine may include at least one of a three-phase switched reluctance motor (SRM) and a three-phase reluctance generator. In some cases, the SRM is configured for magnetic flux to flow axially, parallel to the axis of rotation of the rotor. The state machine may include one of a single stator reluctance state machine, a single stator dual coil reluctance machine, an in-runner reluctance state machine, an out-runner dual rotor reluctance state machine, an out-runner single rotor reluctance state machine, a zero gradient-flux dual stator state machine, and a zero gradient-flux out-runner state machine.

In some cases, the state machine is configured to operate as a motor-generator. The state machine may include and/or interface with an energy storage element configured to release magnetic stored energy and/or electric stored energy based on the angular position of the rotor assembly. The magnetic stored energy may be stored in at least one transformer. The electric stored energy may be stored in at least one capacitor.

In some cases, the stator assembly may be arranged to generate an electrical signal in response to a rotating magnetic field generated by rotation of the rotor assembly. When the state machine functions as a reluctance generator, the controller is further arranged to: i) receive second sensor data from a second sensor, where the second sensor data includes rotor assembly rotational speed and ii) invert an excitation circuit for each phase of the stator to generate the electrical signal based on the rotor assembly rotational speed and rotor angular position.

In some cases, when the state machine functions as a generator, the controller may be further arranged to i) receive second sensor data from a second sensor, where the second sensor data includes rotor assembly rotational speed and ii) trigger each phase of the stator assembly in advance of the rotor assembly angular position associated with each phase to generate the electrical signal. The electrical signal may be an AC signal. The state machine may include an AC to DC inverter arranged to convert the AC signal to a DC signal. The state machine system may include a power storage and/or power source that includes one or more batteries configured to receive a DC signal and store electrical energy based on the received DC signal.

In some cases, a method is provided for operating a state machine having a stator assembly arranged to generate a rotating electromagnetic field in response to a control signal and a rotor assembly, positioned adjacent to the stator assembly, arranged to rotate in response to the rotating electromagnetic field. The method includes: detecting, via a sensor, an angular position of the rotor assembly; outputting, by the sensor, sensor data based on the angular position of the rotor assembly; and receiving the sensor data and adjusting the control signal based on the angular position of the rotor assembly to adjust a torque of associated with the rotor assembly when the state machine functions as a motor or to adjust a power output from the stator assembly when the state machine functions as a generator.

Any two or more of the features described in this specification, including in this summary section, may be combined to form implementations not specifically described in this specification. Furthermore, while this specification may refer to examples of systems, methods, and devices related to electric motors, such techniques also apply equally to electric generators.

The details of one or more implementations are set forth in the accompanying drawings and the following description. Other features and advantages will be apparent from the description and drawings, and from the claims.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a cross-sectional view of a known radial flux three phase salient pole switched reluctance motor;

FIG. 2 is a perspective view of an axial flux switched reluctance motor and/or generator (AFSRM) in accordance with at least some embodiments;

FIG. 3 is a front view of the AFSRM shown in FIG. 2;

FIG. 4 is a side view of the AFSRM shown in FIG. 2;

FIG. 5 is an exploded view of the AFSRM shown in FIG. 2;

FIG. 6A is an exploded view of another embodiment of an AFSRM, in accordance with at least some embodiments; FIG. 6B is a perspective of the AFSRM in FIG. 6A, but without a cover; and FIG. 6C is a cross-section side view of the AFSRM in FIG. 6A;

FIG. 7 is a schematic of an AFSRM showing different phases, in accordance with at least some embodiments;

FIG. 8 is a cross-sectional view of an electromagnet used in an AFSRM, in accordance with at least some embodiments;

FIG. 9A is a front view showing a magnetic flux path in an AFSRM, in accordance with at least some embodiments; and FIG. 9B is a perspective view of the magnetic flux path shown in FIG. 9A;

FIG. 10 is a control circuit for an AFSRM with three phases, in accordance with at least some embodiments;

FIG. 11 is a graph of angle versus inductance/motoring current/generating current for one given phase in an AFSRM, in accordance with at least some embodiments;

FIG. 12 is a graph of angle versus inductance for three phases in an AFSRM, in accordance with at least some embodiments;

FIG. 13 is a graph of input voltage versus rotation angle for three phases in an AFSRM, in accordance with at least some embodiments;

FIG. 14 is a graph of input voltage versus time for three phases in an AFSRM, in accordance with at least some embodiments;

FIG. 15 is a graph of input current versus time for three phases in an AFSRM, in accordance with at least some embodiments;

FIG. 16 is a graph of angle versus motoring current/generating current for three phases in an AFSRM, in accordance with at least some embodiments;

FIGS. 17A and 17B are gradient plots of magnetic flux density at different times for an AFSRM, in accordance with at least some embodiments;

FIG. 18 is an exploded view of another embodiment of an AFSRM, in accordance with at least some embodiments;

FIG. 19 is a perspective view of another embodiment of an AFSRM that includes a mounting bracket, in accordance with at least some embodiments;

FIGS. 20, 21 and 22 are screenshots of a system operation software while operating an AFSRM, in accordance with at least some embodiments;

FIG. 23 is a block diagram of a system for controlling a motor and/or a generator, such as AFSRM, in accordance with at least some embodiments;

FIG. 24 is a diagram of a computer system implemented for use in the controller, in accordance with at least some embodiments;

FIG. 25 is a flow diagram of a process for operating a switched reluctance motor, in accordance with at least some embodiments.

### DETAILED DESCRIPTION

In an example embodiment, a switched reluctance motor with an axial flux geometric configuration is provided. The difference between a radial flux switched reluctance motor and axial flux switched reluctance motor is the orientation of the salient stator poles. The salient stator poles in a radial flux motor are oriented parallel to the axis of rotation, where in an axial flux motor, the salient stator poles are normal to the axis of rotation. In this embodiment of a hybrid axial-flux switched reluctance motor, as with other axial flux motors, the salient poles are normal to the axis of rotation.

In a conventional radial flux switched reluctance motor, stator poles and associated coils run parallel to the axis of rotation of the motor. The new geometric configuration, of the embodiments described herein, is an axial flux switched reluctance motor (AFSRM). In some cases, the stator poles and associated coils of an AFSRM are oriented to be normal to the axis of rotation. An AFSRM does not utilize rare earth magnets or windings on the rotor. In some cases, the AFRSM described herein does not include rare earth magnets nor permanent magnets on the rotor or the stator.

In some cases, an AFSRM is adapted to industrial applications which require torque generation, including for example, screw compressors, blowers, air conditioning compressors, conveyers, and automotive vehicles. In some cases, an AFSRM is also adapted to applications for electrical power generation. In other words, an AFSRM can be configured in a system to supply electrical power when attached to a prime mover.

In some cases, a control system of an AFSRM operation provides independent control of each phase with respect to rotor angular position. Angular position of the rotor determines the inductance of each phase. As the rotor approaches the centerline of the salient stator pole it acts as a motor. As the rotor passes the centerline of the salient stator pole it acts as a generator. Someone having ordinary skill in the art will be able to operate the AFSRM utilizing a typical control circuit containing semiconductor power electronics.

In some cases, the axial flux switched reluctance motor has a geometric configuration where the stator salient poles and associated coils are normal to the axis of rotation. In some cases, the AFSRM has a 6/4 configuration indicating 6 stationary salient stator poles and 4 movable rotor poles. Other configurations with different ratios of salient stator poles to rotor poles can be applied to the AFSRM. In some cases, there are more stationary salient stator poles compared to the number of movable rotor poles.

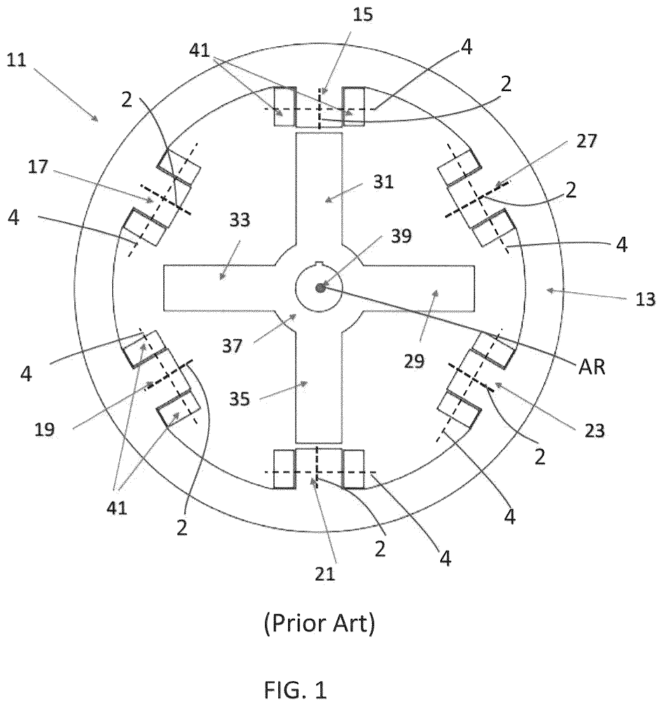

Turning to FIG. 1, a known construction of a radial flux three phase salient pole switched reluctance motor 11 is shown from a cross-sectional view. The motor 11 includes an outer stator 13 and a rotor 37 that spins about an axis of rotation AR. The axis of rotation AR of the rotor 37 is aligned with a shaft 39, whereby the rotor 37 is connected to the shaft 39, and are mechanically coupled and keyed together. In some cases, the axis of rotation of the rotor AR is illustrated in FIG. 1 as the center point of the shaft 39, and the axis or rotation of the rotor AR extends out of the page.

In some cases, as illustrated in FIG. 1, the outer stator 13 includes a ring structure with six salient poles, 15, 17, 19, 21, 23, 27 protruding inwards towards the axis of rotation AR of the rotor 37, and each salient stator pole has an electrically conductive coil 41 (e.g., an insulated wire) wrapped around itself to generate an electromagnetic force when electricity passes through the coil 41. In some cases, each coil is wound around a pole in diametrically opposed pole pairs. For example, poles 15 and 21 form a pole pair, poles 17 and 23 form a pole pair, and poles 19 and 27 form a pole pair. In some cases, the coils 41 are wound about an axis 2 of each salient pole, whereby an axis 2 of each salient stator pole is oriented normal to the axis of rotation AR of the rotor 37 and each axis 2 points radially inwards to the axis of rotation AR of the rotor 37.

It will be appreciated that the term “normal” is also herein considered to be perpendicular. For example, two lines can be perpendicular to each other; a line and a plane can be perpendicular to each other; and two planes can be perpendicular to each other. The use of “normal” and “perpendicular” in this document includes approximately normal and approximately perpendicular.

It will be appreciated that the coils 41 are illustrated as two portions on opposite sides of a salient stator pole, since a cross-section is taken through each of the stator poles. It will be appreciated that the coil is wound continuously around each protruding stator pole.

In some cases, each coil 41 is considered to define a plane 4 that is illustrated in FIG. 1 and extends out of the page. Each plane 4 corresponding to each coil 41 is parallel to the axis of rotation AR. Furthermore, for each given salient stator pole, each axis 2 of a given stator pole and each corresponding plane 4 are oriented normal to each other.

The pole pairs are connected in series to form a phase creating a three-phase machine, including Phase A formed by pole pair 15 and 21, Phase B formed by pole pair 17 and 23, and Phase C formed by pole pair 19 and 27. The rotor 37 has four rotor poles 29, 31, 33, 35 affixed to a shaft 39. In some cases, operation of a SRM motor includes each phase being connected to an electrical source through a semiconductor power stage. In some cases, each phase is energized when the rotor pole is at maximum magnetic reluctance and de-energized at minimum magnetic reluctance.

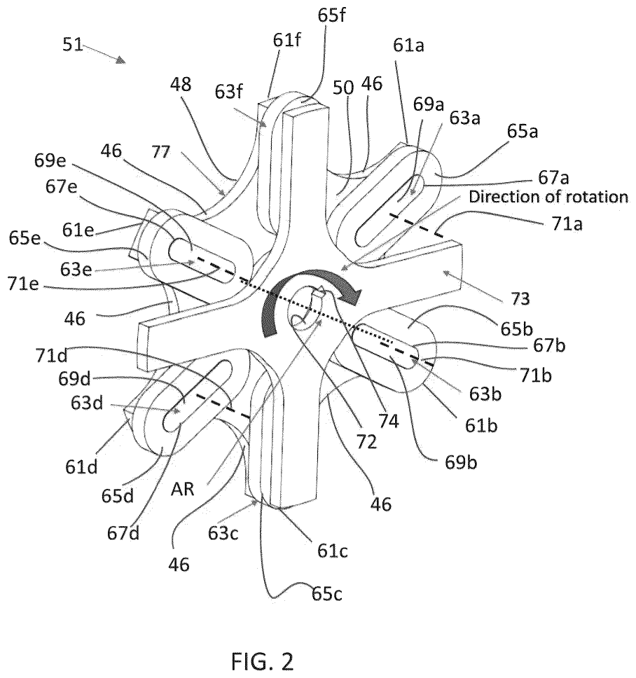

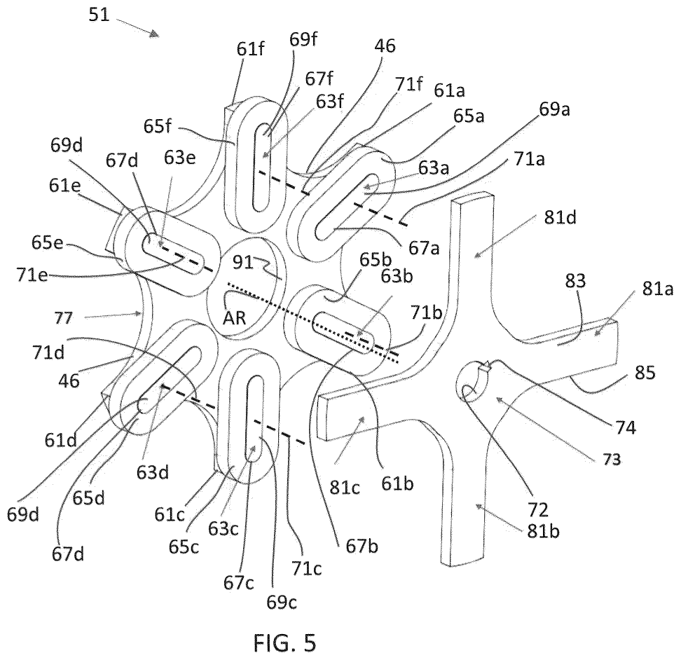

Turning to FIGS. 2 to 5, various illustrations of an embodiment of an AFSRM 51 are shown. The AFSRM 51 includes a stator 77 and a rotor 73. In FIG. 5, a shaft 75 extends through a void defined by an inner wall 72 of the rotor 73 (seen best in FIG. 2). Also shown in FIGS. 5 and 2 is a keying feature 74 extends from the inner wall 72, which is configured to couple with a complementary keying feature of the shaft. The keying feature of the rotor and the complimentary keying feature of the shaft are used to mechanically transfer the rotation of the rotor to the shaft, or mechanically transfer the rotation of the shaft to the rotor.

The stator 77 includes a front surface 50 and an opposite facing rear surface 48. Side walls 46 extend between the front surface 50 and the rear surface 48. Six protrusions 61a, 61b, 61c, 61d, 61e, 61f extend radially outwards from the center of the stator, and are in plane with the front surface 50 and the back surface 48. Side walls 46 connect between each of the protrusions 61a, 61b, 61c, 61d, 61e, 61f, and each of the protrusions respectively forms a salient stator pole 63a, 63b, 63c, 63d, 63e, 63f. Each of the salient stator poles 63a, 63b, 63c, 63d, 63e, 63f respectively include a corresponding bobbin 67a, 67b, 67c, 67d, 67e, 67f that protrudes in a direction normal to the front surface 50 of the stator 77. In some cases, the direction that each bobbin protrudes from the front surface 50 respectively defines a corresponding axis 71a, 71b, 71c, 71d, 71e, 71f. Each of these axes 71a, 71b, 71c, 71d, 71e, 71f are parallel to the axis of rotation AR of the rotor 73.

The bobbins 67a, 67b, 67c, 67d, 67e, 67f each respectively have a corresponding coil 65a, 65b, 65c, 65d, 65e, 65f of electrically insulated and conductive wire wound therearound the given bobbin.

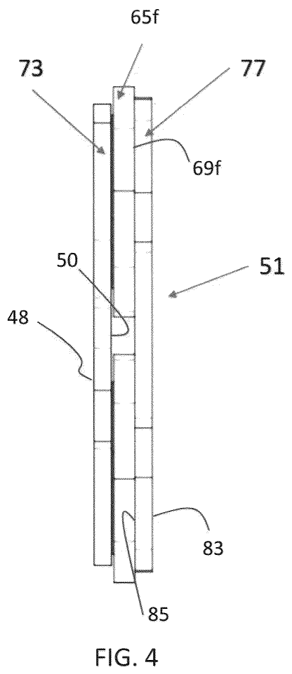

The bobbins 67a, 67b, 67c, 67d, 67e, 67f each respectively have a corresponding bobbin front surface 69a, 69b, 69c, 69d, 69e, 69f that are each oriented perpendicular to the respective axes 71a, 71b, 71c, 71d, 71e, 71f. In some cases, bobbin front surfaces 69a, 69b, 69c, 69d, 69e, 69f are flat or planar, and are coplanar with each other. As best seen in the side view in FIG. 4, the bobbin front surfaces 69a, 69b, 69c, 69d, 69e, 69f face towards a back surface 85 of the rotor 73. The bobbin front surfaces 69a, 69b, 69c, 69d, 69e, 69f and the back surface 85 of the rotor 73 are spaced such that flux linkage may occur without interference, so that the rotor 73 can spin relative to the stator 77. In some cases, the coil 65 wound around each bobbin 67 does not extend past a plane defined by the front surface 69 of the bobbins, so as not to create any mechanical obstruction when a rotor pole 81 passes over the bobbin front surface 69. In some cases, the coil 65 is wound around a bobbin 67 so that a bottom surface of the coil is bound by the front surface 50 of the stator and a top surface of the coil is coplanar with the front surface 69 of the bobbin 69.

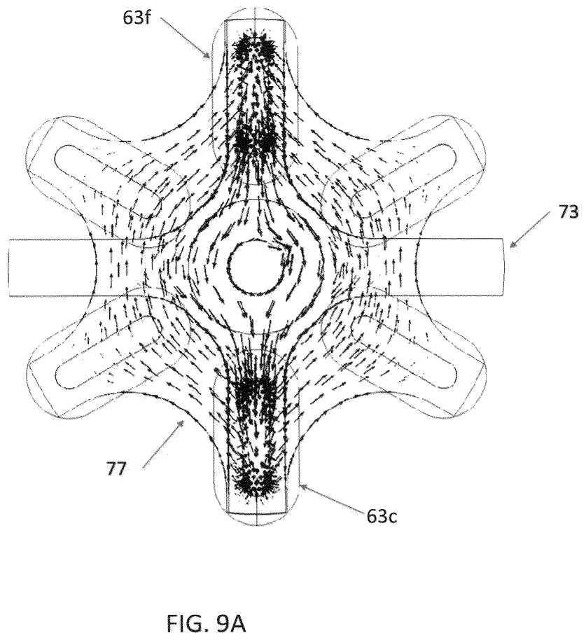

The term “magnetic flux” herein refers to a magnetic field passing through a given area. In some cases, the magnetic field passes through a physical material, such as metal that facilitates magnetic fields to pass therethrough. In some cases, the metal comprises ferromagnetic metal. Example embodiments of magnetic flux flow are shown in FIGS. 9A and 9B. The following section describes the mechanical design, which, in some cases, improves magnetic flux flow.

As will be described in more detail below, the bobbin front surfaces 69a, 69b, 69c, 69d, 69e, 69f and the back surface 85 of the rotor 73 should be spaced close enough together to allow the magnetic flux to flow between any given one of the rotor poles 81a, 81b, 81c, 81d, when a given rotor pole 81 passes over any of the bobbin front surfaces 69a, 69b, 69c, 69d, 69e, 69f. The rotor poles 81a, 81b, 81c, 81d may also be referred to as rotor lobes. In particular, when electricity flows through a first coil 65, a magnetic field is generated in a first bobbin 67 around which the first coil 65 is wound and magnetic flux flows axially along the first bobbin's axis 71 and parallel to the axis of rotation AR of the rotor 73, and through a back surface 85 of a first rotor pole 81 passing over the bobbin's front surface 69. The magnetic flux flows across the rotor towards a second rotor pole, whereby the first rotor pole and the second rotor pole are diametrically positioned from each other and form a rotor pole pair. The magnetic flux flows out a back surface 85 of the second rotor pole and into a front surface of a second bobbin 67 along the second bobbin's axis 71 (which is also parallel to the axis of rotation AR of the rotor 73). The second bobbin 67 and the first bobbin are part of a stator pair and are diametrically positioned opposite to each other. Furthermore, the second coil 65 wound around the second bobbin is electrically energized at the same time as the first coil around the first bobbin.

In other words, as shown in FIGS. 2 to 5, a given salient stator pole 63 includes a bobbin 67 with a front surface 69, and a coil 65 is wound around the bobbin 67. The bobbin 67 protrudes from a front surface 50 of the stator, defining an axis of the bobbin 71 that is parallel to the axis of rotation AR of the rotor 77.

In some cases, the coil 65 is wound normal about the axis of the bobbin. In other words, the coil 65 of each salient stator pole 63 is wound normal to the axis of rotation AR of the rotor 73.

In some cases, the coil 65 is electrically insulated aluminum wire. In some cases, aluminum wiring is advantageous over other wiring metals, since aluminum wiring is less dense. In some cases, an AFSRM made with aluminum wiring for the coils 65 will be lighter than using copper wiring in the coils, since copper is more dense than aluminum.

The terms “aluminum wire” and “aluminum wiring” as used herein refer to wire made from an aluminum alloy or pure aluminum. In some cases, aluminum wire is formed from 99% (or higher) pure aluminum.

In some other cases, the coil 65 is electrically insulated copper wire.

The bobbin 67 in FIGS. 2 to 5 is shown to have an elongate rectangular profile with rounded ends. The coil 65 has a similar profile around the bobbin 67. It will be appreciated that other profile shapes for the bobbin 67 can be used.

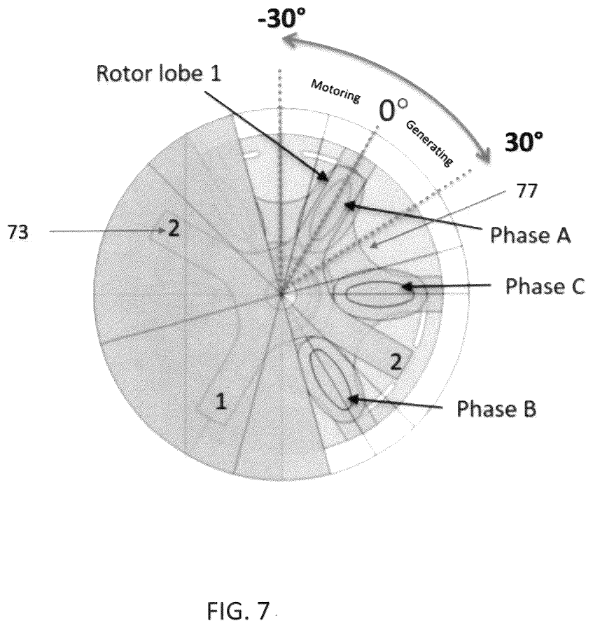

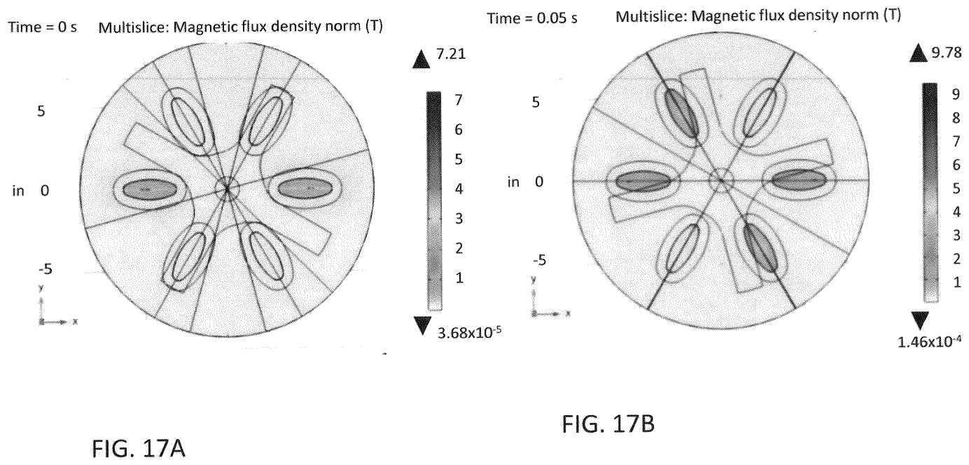

In some other cases, the bobbin 67 has an oval-like profile and the coil 65 has a similar profile around the bobbin 67. An oval-like profile provides more gradual bending or curves. In some cases, this oval-like profile facilitates easier fabrication. An example of an oval-like profile for bobbins is shown in FIG. 7 and in FIGS. 17A, 17B. In some cases, the bobbins have an elliptical profile shape.

In some cases, triangular or pie-shaped bobbins and coil configurations have been used in other electrical motors to optimize use of the circular area of the motor, but this may lead to unsteady flux gradients in motor operation. In some cases, the rounded and elongate shapes described provide a smoother flux gradient as the rotor lobes pass over the salient stator poles.

In some other cases of the AFSRM, different profile shapes can be used for the bobbin and the coil wound around the bobbin. These different profile shapes include, for example, squares, polygons, pie shapes, irregular shapes, or other round or oblong shapes.

Turning back to FIGS. 2 to 5, in some cases, the profile of the bobbin is elongate and it includes a major dimension and a minor dimension, whereby the major dimension extends radially away from the center of the stator, which coincides with the axis of rotation AR of the rotor 73. The minor dimension is the width of the bobbin, and it is less than the length of the major dimension. This facilitates a greater surface area of the bobbin's front face 69 coinciding with a rotor pole 81, which is also elongate and extends radially from the axis of rotation AR, when a rotor pole 81 passes over the bobbin's front face 69.

In some cases, the stator 71 also includes an inner wall 91 that defines therein a void that is centered with the stator. For example, the void defined by the inner wall 91 is circular and is concentric with the axis of rotation AR of the rotor 73. In some cases, the shaft extends through the void of the stator 71.

In some cases, in each of a first pole pair 63f and 63c, a second pole pair 63b and 63e, and a third pole pair 63a and 63d, the poles in each pole pair are diametrically opposed and concentric to the axis of rotation. The pole pairs are connected in series creating a three-phase motor, Phase A (e.g., comprising a first pole pair 63f and 63c), Phase B (e.g., comprising a second pole pair 63b and 63e), and Phase C (e.g., comprising a third pole pair 63a and 63d). The rotor, 73, has four salient poles 81a, 81b, 81c, 81d that are affixed to a rotatable shaft 75 concentric to the axis of rotation.

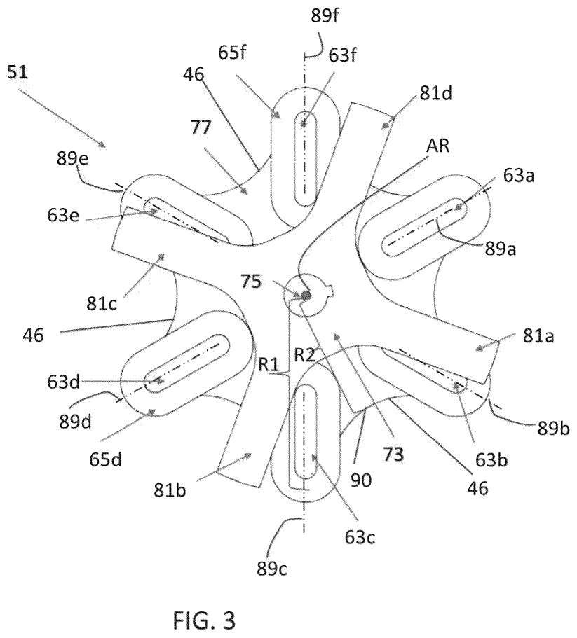

In some cases, when operating an AFSRM, the phases are energized while the rotor and stator are at a maximum magnetic reluctance state, until a minimum magnetic reluctance state occurs between the rotor and stator, at which time the phase energization ceases. In some cases, maximum magnetic reluctance occurs at −30 degrees from the centerline of the salient stator poles. As best illustrated in FIG. 3, the center lines 89a, 89b, 89c, 89d, 89e, 89f respectively correspond to the salient stator poles 63a, 63b, 63c, 63d, 63e, 63f. Minimum reluctance is achieved when a rotor pole is perfectly aligned with the centerline of a salient stator pole. In some cases, sequential electrical energization of the coils of Phase A (e.g., comprising a first pole pair 63f and 63c), Phase B (e.g., comprising a second pole pair 63b and 63e), and Phase C (e.g., comprising a third pole pair 63a and 63d), at maximum magnetic reluctance until a state of minimum magnetic reluctance causes rotation of the rotor 73 resulting in torque production transferred to the shaft.

In some cases, a three-phase AFSRM operates as a generator and, in such case, at minimum magnetic reluctance, a phase is pulse energized, creating a mutual induction condition resulting in flux linkage between the salient stator pole and the rotor pole. As a rotor pole rotates past the centerline of the salient stator pole, the energization of the phase ceases. The change in inductance as the rotor rotates past the salient stator pole centerline results in power generation in the form of back EMF voltage.

In some cases, a three-phase AFSRM operating as a generator achieves minimum magnetic reluctance when the rotor pole is perfectly aligned with the centerline of the salient stator pole. In some cases, maximum magnetic reluctance is achieved at 30 degrees past the salient stator pole centerline. Phase A (e.g., comprising a first pole pair 63f and 63c), Phase B (e.g., comprising a second pole pair 63b and 63e), and Phase C (e.g., comprising a third pole pair 63a and 63d), are sequentially energized with a pulse at minimum reluctance and to initiate flux linkage between the rotor pole resulting in electrical power generation through the coils.

FIG. 2 shows an example direction of rotation in the clockwise direction. However, the direction of rotation in the counterclockwise direction can also be achieved. For example, changing the sequential excitation of the phases can cause the rotor to rotate in a different direction.

In some cases, the bobbins and the stator are made of a single piece. In some other cases, the bobbins are separate pieces that are affixed or integrated with the stator, so that magnetic flux can flow through the stator and towards and through the bobbins. Different types of fasteners, screws, and other joinery mechanisms can be used to affix a bobbin to a stator.

The stator and the bobbins are made of, at least in part or entirely, a magnetically permeable material that allows the flow of magnetic flux through the material. The rotor is made of, at least in part or entirely, a magnetically permeable material that allows the flow of magnetic flux through the material. In some cases, the stator, the bobbins and the rotator are made of the same magnetically permeable material. In some cases, the metal material is a type of steel, such as a steel alloy.

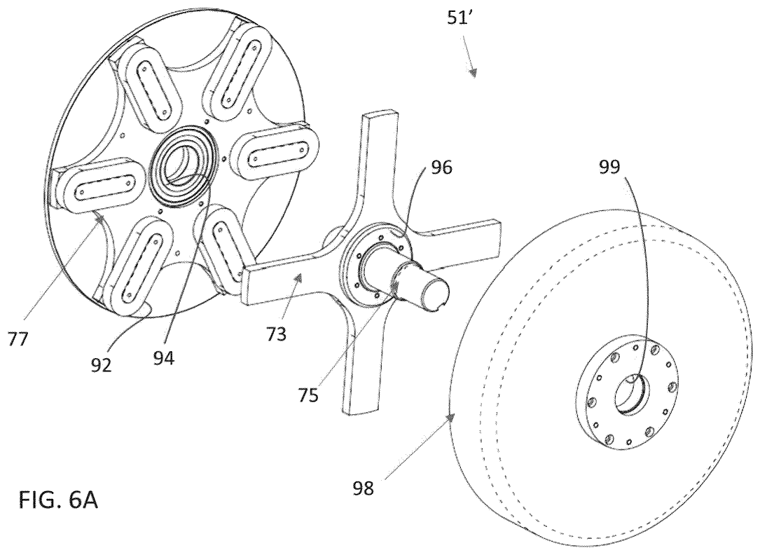

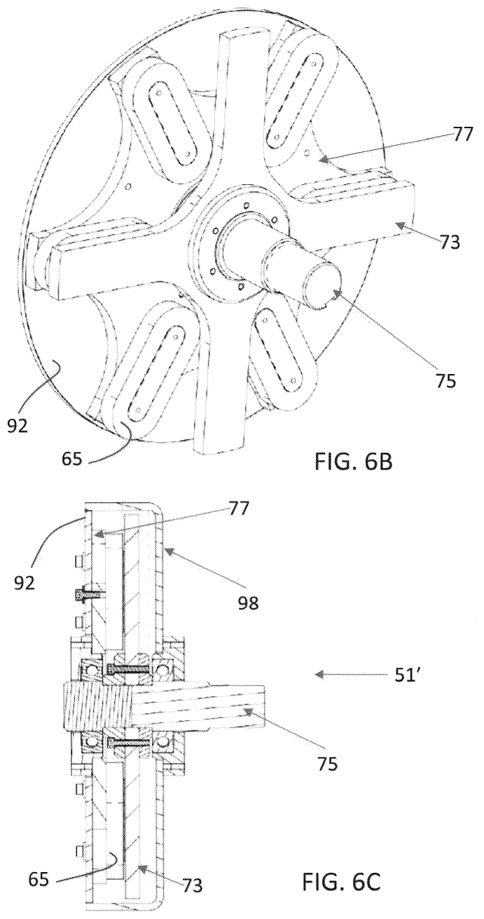

Turning to FIGS. 6A, 6B and 6C, another embodiment of an AFSRM 51′ is provided, which includes a backing plate 92 affixed to the stator 77. A rotary bearing 94 is positioned at the center of the stator 77 and extends through the center of the backing plate 92. A portion of the shaft 75, which is coupled and affixed to the rotor 73, extends through the circular opening of the rotary bearing 94. In some cases, a flange 96 is used to help affix the shaft 75 to the rotor 73. The AFSRM 51′ also includes a cover 98 that will house the stator 77 and the rotor 73. Another portion of the shaft 75 extends through an opening 99 defined in the center of the cover 98. It will be appreciated in FIG. 6B, the cover 98 is not shown.

FIG. 7 illustrates the phase definition of an AFSRM 51. Clockwise rotation of the rotor while sequentially energizing Phase A (e.g., comprising a first pole pair 63f and 63c), Phase B (e.g., comprising a second pole pair 63b and 63e), and Phase C (e.g., comprising a third pole pair 63a and 63d) between −30 degrees and 0 degrees will result in rotation of the rotor of the AFSRM 51, resulting in torque generation.

Clockwise rotation of the rotor while sequentially energizing Phase A (e.g., comprising a first pole pair 63f and 63c), Phase B (e.g., comprising a second pole pair 63b and 63e), and Phase C (e.g., comprising a third pole pair 63a and 63d), with a pulse as the rotor pole passes 0 degrees will result in an axial flux switched reluctance generator 51 operating to generate electrical power through its coils 67. The above example states clockwise rotation but by changing the sequential excitation order of the phases the AFSRM can operate in a counterclockwise direction.

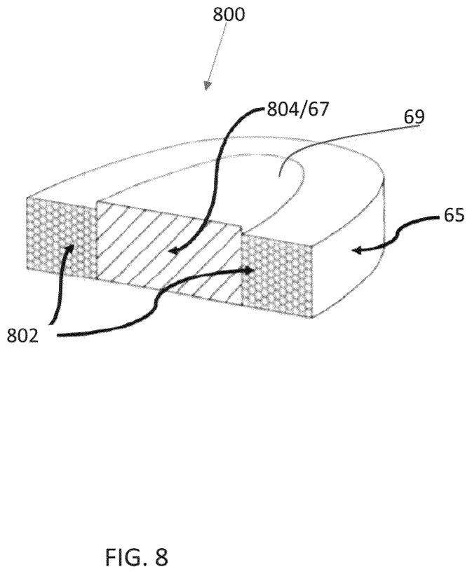

Turning to FIG. 8, a cross-section view of an example embodiment of an electromagnet 800 is shown within a stator pole of an AFSRM. In some cases, the electromagnet includes multiple conductor loops 802 that are wound around a magnetically permeable core 804. The magnetically permeable core 804 forms a bobbin 67. The collection of the multiple conductor loops 802 form a coil 65. In some cases, the magnetically permeable core 804 includes a metal, such as steel, M-19 electrical steel, and/or other magnetically permeable material. In some cases, the heat generation of the AFSRM is significantly improved due to the geometric construction of the electromagnets at each of the stator poles, and due to the control of electrical excitation by a controller 102.

In some cases, heat generation resulting from motor operation can be controlled in a few ways. In some cases, vertical and horizontal placement of every conductor loop 802 in the coil 65 is defined geometrically with respect to a certain local cartesian coordinate system. This ensures a defined and repeatable thermal characteristic for every coil 65. In some cases, there are very few and/or very small internal gaps between conductors 802 within a given coil 65. This results in an internal conductive thermal path versus a mix of conductive and convective thermal paths. In some other cases, the geometry of an AFSRM provides a shortened direct path for heat generated to reach ambient air and be removed via convection. Internally conduction is the dominant phenomena, while externally convection occurs from the outer surface of the coil. For example, conduction occurs through the pole of a stator and the heat is then removed via convection. In some other cases, windage resulting from rotor rotation creates a forced convection phenomena over the heat generating geometry of the coil 65. The heated air can be evacuated from the internals of the AFSRM.

In some cases, the temperature of the coils at each bobbin in the stator reaches a high temperature. In some cases, the temperature of the coils and other components in the AFSRM exceeds 100 degrees Celsius while remaining operational. In some cases, the components of the AFSRM are rated to withstand temperatures over 100 degrees Celsius. In some cases, the AFSRM does not have any permanent magnets. In some cases, permanent magnets lose their magnetism as temperatures increase, and the AFSRM is not affected by this property of permanent magnets as it does not utilize permanent magnets.

In some cases, the coil 65 of electrically insulated wire wound around a given bobbin on the stator 77 is encapsulated in an encapsulation compound that has an operating temperature of over 150 degrees Celsius. In some cases, the encapsulation compound that has an operating temperature of over 180 degrees Celsius. In some cases, the encapsulation compound that has an operating temperature of over 200 degrees Celsius. In some cases, the encapsulation compound that has an operating temperature of over 250 degrees Celsius.

In some cases, the AFSRM is provided an input power of over 700 Watts (W), and the rotor 73 and/or the shaft 75 achieves a speed of over 8000 Rotations Per Minute (RPM), without a load on the shaft 75. In some cases, the AFSRM a coil temperature of over 150 degrees Celsius.

In some cases, the AFSRM is provided an input voltage of approximately 106 Volts (V), an input current of approximately 6.7 Amps (A), resulting in an input power of approximately 711 W. In this case, the AFSRM's rotor 73 and/or shaft 75 achieves a speed of approximately 8116 RPM while the coils operate at a temperature approximately 181 degrees Celsius.

In some cases, the AFSRM operates with a coil temperature of at least 150 degrees Celsius and at a shaft speed of over 5000 RPM. In some cases, the AFSRM operates with a coil temperature of at least 150 degrees Celsius and at a shaft speed of over 6000 RPM. In some cases, the AFSRM operates with a coil temperature of at least 150 degrees Celsius and at a shaft speed of over 7000 RPM. In some cases, the AFSRM operates with a coil temperature of at least 150 degrees Celsius and at a shaft speed of over 8000 RPM.

In some cases, the AFSRM is provided an input voltage of 100 V. In some cases, the AFSRM coil temperature of at least 150 deg C, and RPM of at least 6000 RPM.

In some cases, the axial flux switched reluctance motor sustains operating with the shaft speed of at least 8000 RPM for at least 30 minutes. In some cases, the axial flux switched reluctance motor sustains operating with the shaft speed of at least 8000 RPM for at least one hour.

In some cases, an input voltage of 106 Volts, an input current of 6.7 Amps, and an input power of 711 Watts is provided to the axial flux switched reluctance motor; and the shaft speed is over 8100 RPM and the temperature of the coil is at least 180 degrees Celsius. In some cases, the temperature of the coil is at least 200 degrees Celsius. In some cases, the temperature of the coil is at least 210 degrees Celsius. In some cases, the axial flux switched reluctance motor sustains operating at over 8000 RPM and at least 200 degrees Celsius for at least 30 minutes.

In some cases, an input voltage of over 59 Volts is provided to the axial flux switched reluctance motor.

In some cases, an input voltage of between 59 and 61 Volts is provided to the axial flux switched reluctance motor, and the axial flux switched reluctance motor operates at the shaft speed of over 5700 RPM. In some cases, the axial flux switched reluctance motor sustains operating at the shaft speed of over 5700 RPM for at least 30 minutes.

In some cases, the axial flux switched reluctance motor sustains operating at the shaft speed of over 5000 RPM for at least one hour. In some cases, the axial flux switched reluctance motor sustains operating at the shaft speed of over 5000 RPM for at least three hours. In some cases, the axial flux switched reluctance motor sustains operating at the shaft speed of over 6000 RPM for at least one hour.

In some cases, a pulsed timing and trigger controller (PTTC) controls current or voltage, whether it is an inductor or a capacitor, and thereby controls magnetism of a stator pole in an AFSRM.

Furthermore, in some cases, heat generation is controlled by controller 102 using, for example, a pulsed timing and trigger controller (PTTC) program and/or function. Heat generation within an electric motor for example is a form of input energy not used for torque or power generation. The PTTC program and/or function run by the controller 102 closely monitors heat generation resulting from motor operation. Except for the case of intermediary conditions where maximum torque or power generation is requested by the operator, heat generation has an upper boundary set by the controller 102. In some cases, the controller 102 adjusts a motor control signal based on the angular position of the rotor assembly and on the detected temperature of the motor, to adjust a torque associated with the rotor 73 to prevent the temperature of the motor from exceeding an upper temperature boundary and or limit. The upper temperature boundary and/or limit may be preset within memory and the controller 120 may compare sensed more temperature with the stored temperature limit to determine how close the present motor temperature is to the limits, and adjust a motor control signal accordingly to prevent an over temperature condition.

In some other cases, another type of motor controller is used to control the AFSRM.

FIG. 9A illustrates an example embodiment of a magnetic flux path in an AFSRM 51 when Phase A (e.g., comprising a first pole pair 63f and 63c) is energized. When phase A is energized the flux travels through the rotor 73 and stator 77, salient stator poles, 63f and 63c, thereby forming a magnetic flux loop. The flux characteristics shown are at a minimum reluctance condition indicating the rotor poles are aligned with the energized stator poles 63f and 63c.

FIG. 9B illustrates an example embodiment of a magnetic flux path in an isometric view of an AFSRM 51, distributed through the rotor 73, the stator 77, a pair of salient stator poles 63f and 63c, when Phase A (e.g., comprising a first pole pair 63f and 63c) is energized at the minimum reluctance. FIG. 9B corresponds to FIG. 9A. As better seen in FIG. 9B, the looping path of the magnetic flux flow is illustrated from the stator to the rotor. The magnetic flux flows from the bobbin 67f in a direction along the bobbin's axis 71f, and across the front surface 69f of the bobbin to the back surface 85 of a first rotor pole. The magnetic flux path continues around the void in the rotor 73 defined by the inner wall 72 and across to a diametrically positioned second rotor pole. The magnetic flux path travels in a direction along the bobbin's axis 71c across the back surface 85 of the second rotor pole and to the front surface 69c of the bobbin 67c of the salient stator pole 63c. The magnetic flux path continues through the bobbin 67c in a direction along the bobbin's axis 71c, and then in a direction bound by the plane defined by the stator 77 back towards the salient stator pole 63f. As shown in FIG. 9B, the magnetic flux path travels in an axial direction parallel to the axis of rotation AR of the rotor 73.

In the example shown in FIG. 9B, at the stator pole 63f, the electric current flows through the coil 65f in a counterclockwise direction around the axis 71f of the bobbin 67f. At the stator pole 63c, the electric current flows through the coil 65c in a clockwise direction around the axis 71c of the bobbin 67c.

In some cases, as illustrated in the example embodiment of the AFSRM 51 in FIGS. 2 to 5, the side walls 46 between the stator protrusions 61a, 61b, 61c, 61d, 61e, 61f have a concave and curved profile. In some cases, each side wall 46 does not have any corners, but instead is a continuous concave curve. Referring to FIG. 3, in some cases, there is defined a middle point 90 of a sidewall 46, which is equidistant between two neighboring centerlines 89c and 89b of the salient stator poles 63c and 63b. The middle point 90 of the sidewall 46 is a point on the sidewall that is closest to the center of the stator, which concentric with the axis of rotation AR of the rotor 73. In some cases, the distance R1 refers to the radial distance between the center of the stator (e.g., the axis of rotation AR) to the outermost edge of a given stator protrusion 61. The distance R2 refers to the radial distance between the center of the stator and a given middle point 90 of a sidewall, which is also the closest point along the continuously concave curve sidewall to the center of the stator. In some cases, 0.5R1<R2<R1. In some cases, 0.6R1<R2<0.9R1. In some cases, R2 is approximately 0.7R1. It will be appreciated that other ratios relating R2 and R1 together can be used.

In some cases, the continuous concave curve of the sidewall 46 facilitates a higher magnetic flux density of the magnetic flux path across the stator between a pair of salient stator poles. For example, corners or angles in the profile of the sidewall 46 may cause more eddies along the magnetic flux path in the stator.

In some cases, the sidewall has a parabolic profile.

In some other cases, the sidewall 46 has a different shape. For example, the sidewall is formed by two or more straight edges connected at angles to each other. In another example, the sidewall could have a triangular profile. More generally, the profile shape of the stator 77 can vary from the example embodiments shown.

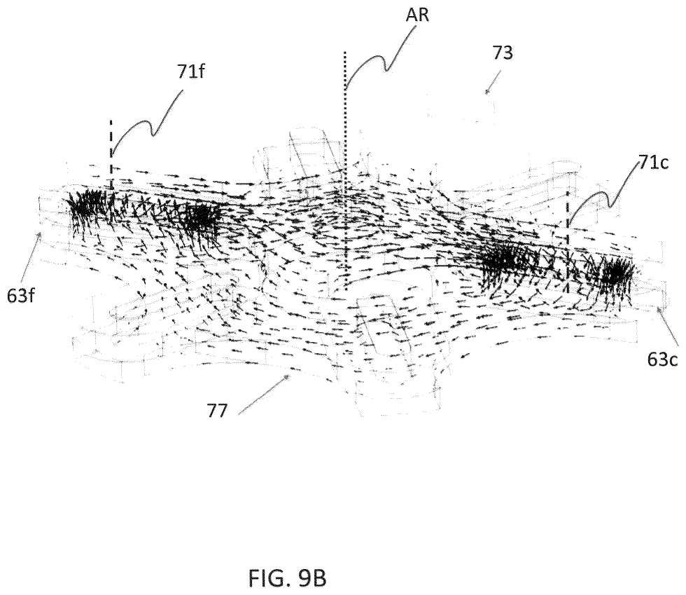

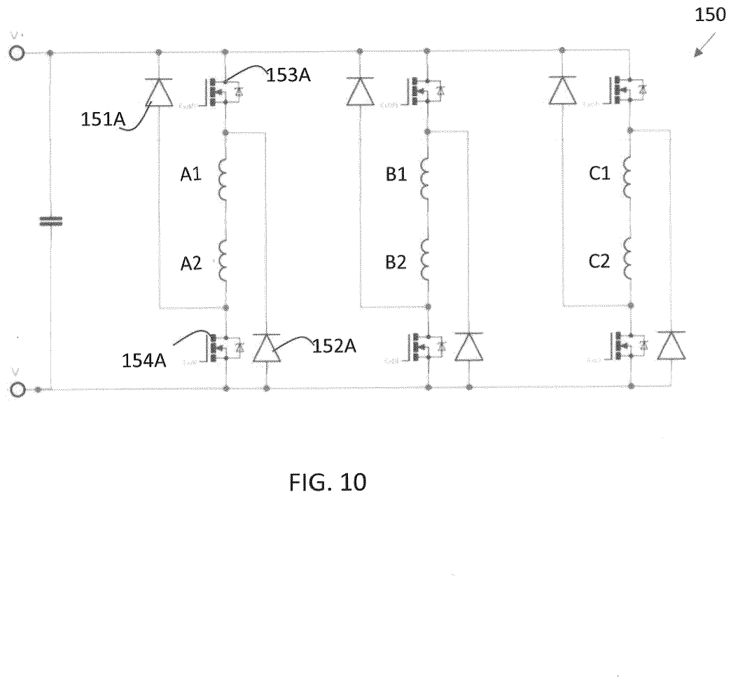

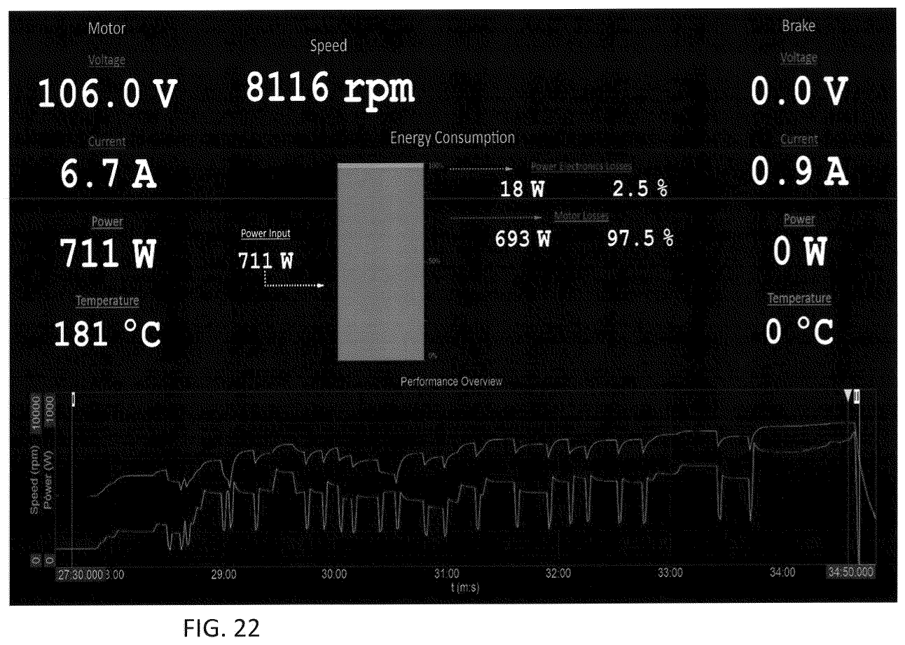

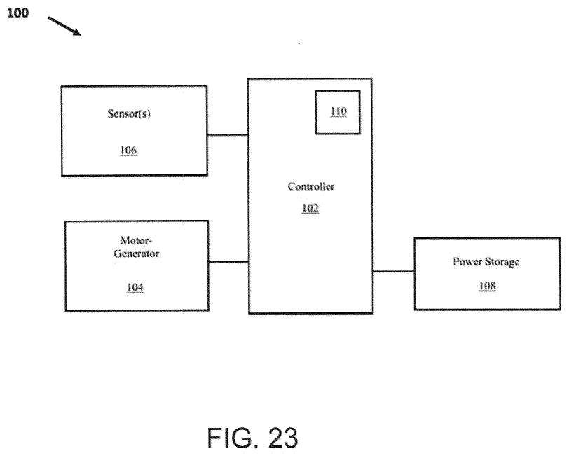

FIGS. 10 to 21 described below relate to the operation of an AFSRM 51 or AFSRM 51′, or both. In some cases, some or all of the characteristics and operation information described in FIGS. 10 to 21 also apply to other embodiments of AFSRM (not limited to AFSRM 51 or AFSRM 51′ or AFSRM 51″ in FIG. 22 or AFSRM′″ in FIG. 23).

FIG. 10 illustrates an example embodiment of a control circuit 150 used for the control of an AFSRM 51. Semiconductor power switches control current flow into each phase and freewheeling diodes allow back electromotive force (back EMF) to return to the power supply and the bypass capacitor. The back EMF is also sometimes referred to as counter electromotive force, which is voltage generated by a running motor that acts to counter the supplied voltage. Current flow into each phase of the motor is independently controlled to optimize performance. Other types of control circuitry can be used to control the AFSRM.

In some cases, the coils A1, A2 in FIG. 10 correspond to the coils of the salient stator pole pair for Phase A (e.g., comprising a first pole pair 63f and 63c, and the coils A1, A2 respectively corresponding to the coils 65f, 65c). The coils B1, B2 correspond to the coils of the salient stator pole pair for Phase B (e.g., comprising a second pole pair 63b and 63e, and the coils B1, B2 respectively corresponding to the coils 65b,65e). The coils C1, C2 correspond to the coils of the salient stator pole pair for Phase C (e.g., comprising a third pole pair 63a and 63d, and the coils C1, C2 respectively corresponding to the coils 65a, 65d).

In FIG. 10, for Phase A, a semiconductor power switch 153A, the coil A1, the coil A2 and another a semiconductor power switch 154A are electrically connected in series between the electrical line V+ and V−. A first end of a freewheeling diode 151A is electrically connected between the coil A2 and the semiconductor power switch 154A, and the second end of the freewheeling diode 151A is electrically connected to the electrical line V+. Current can flow from the first end to the second end of the freewheeling diode 151A. A first end of another freewheeling diode 152A is electrically connected to the electrical line V−, and the second end of the other freewheeling diode 152A is electrically connected between the semiconductor power switch 153A and the coil A1. Current can flow from the first end to the second end of the other freewheeling diode 152A.

Similar configurations for the freewheeling diodes and the semiconductor power switches are shown for Phase B, with coils B1 and B2, and Phase C, with coils C1 and C2.

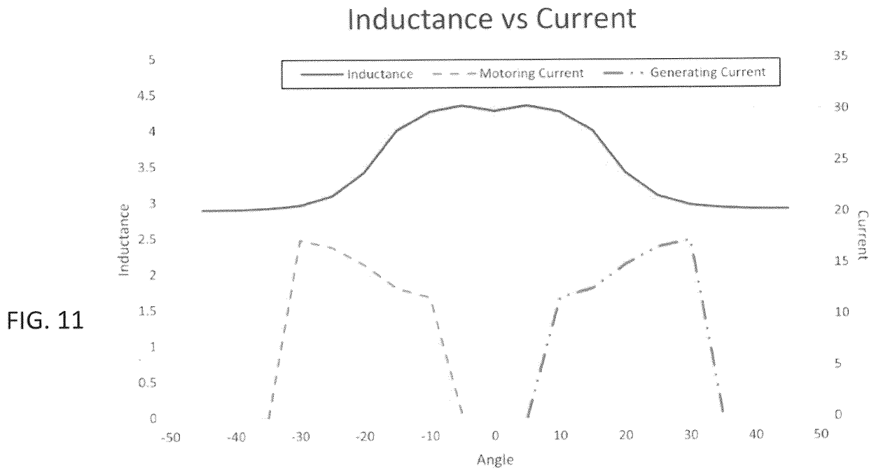

FIG. 11 is a graph which illustrates an example embodiment of a relationship between inductance, angle, motoring current response and generating current response. 0 degrees represents the centerline of the salient stator pole. The AFSRM 51 acts as a motor when a voltage from the control circuit (such as the control circuit 150) energizes a phase in the negative angular region. The current response for the AFSRM is shown as the rotor lobe rotates through the angles −35 to −5 degrees. The AFSRM 51 acts as a generator when a voltage from the control circuit pulse energizes a phase as the rotor rotates passes 0 degrees and continues generating power resulting from flux linkage between the salient stator pole and the rotor pole until 35 degrees when the inductance reaches a minimum value.

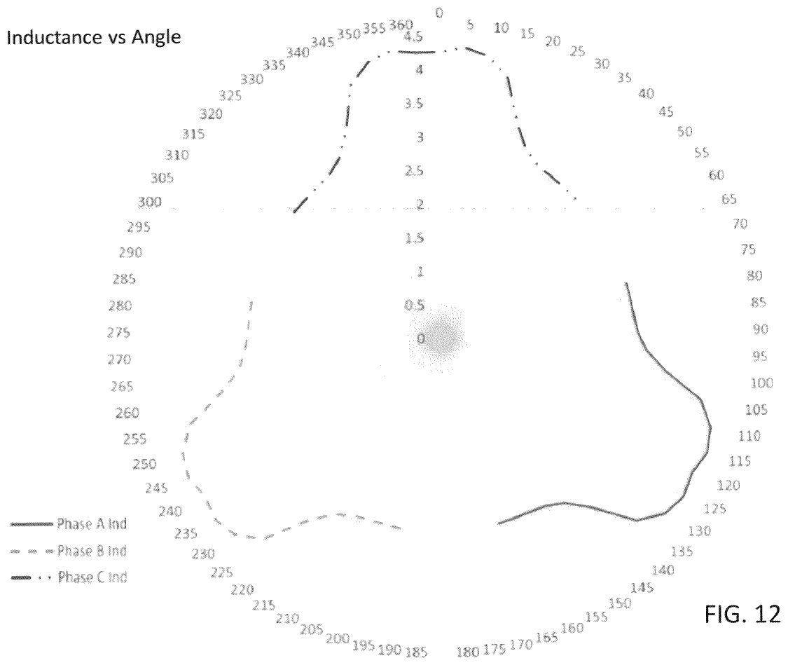

FIG. 12 is a graph illustrating an example embodiment of a relationship between angle and inductance for Phase A (e.g., comprising a first pole pair 63f and 63c), Phase B (e.g., comprising a second pole pair 63b and 63e), and Phase C (e.g., comprising a third pole pair 63a and 63d) that occurs during a 360-degree rotation of the rotor for one rotor lobe. A positive slope of inductance for any phase indicates a motoring condition. A negative slope of inductance for any phase indicates a generating condition.

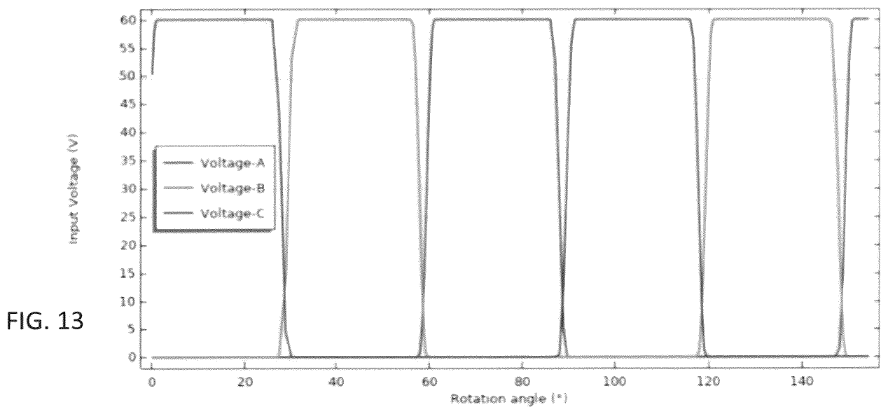

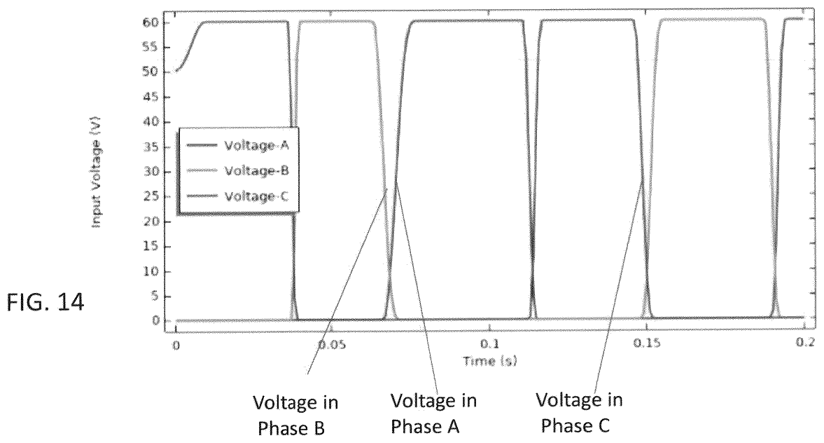

FIG. 13 is a graph detailing the phase voltage excitation versus angular position, according to some example embodiments. The phase voltage excitation of an AFSRM 51 is a non-sinusoidal periodic waveform with fixed maximum and minimum values most closely resembling a square wave. Voltage excitation of each phase is determined by angular position of the rotor ensuring excitation occurs at the desired inductance value. FIG. 14 is a graph of phase voltage excitation versus time.

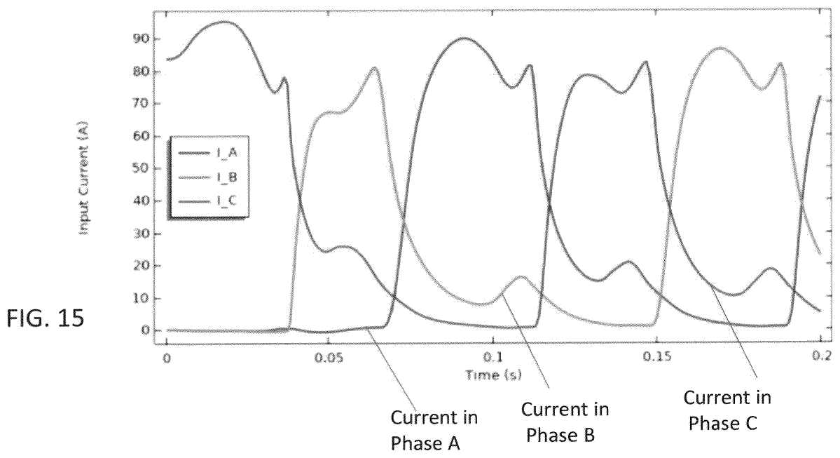

FIG. 15 is a graph of an example embodiment of a phase current response to phase voltage excitation versus time. The phase current profile indicates that the current response is non-linear due to the transient behavior of the phase coils. The graph includes the current behavior at start up where the rotor transitions from stationary to rotating. The current draw for Phase A (e.g., comprising a first pole pair 63f and 63c), from time 0 s to time 0.04 s indicates a higher current draw when compared to time 0.04 s to time 0.2 s where the behavior is periodic. It can also be seen in this example embodiment graph that multiple phases can be energized simultaneously at time 0.04 s, time 0.075 s, time 0.125 s, time 0.16 s, and time 0.18 s.

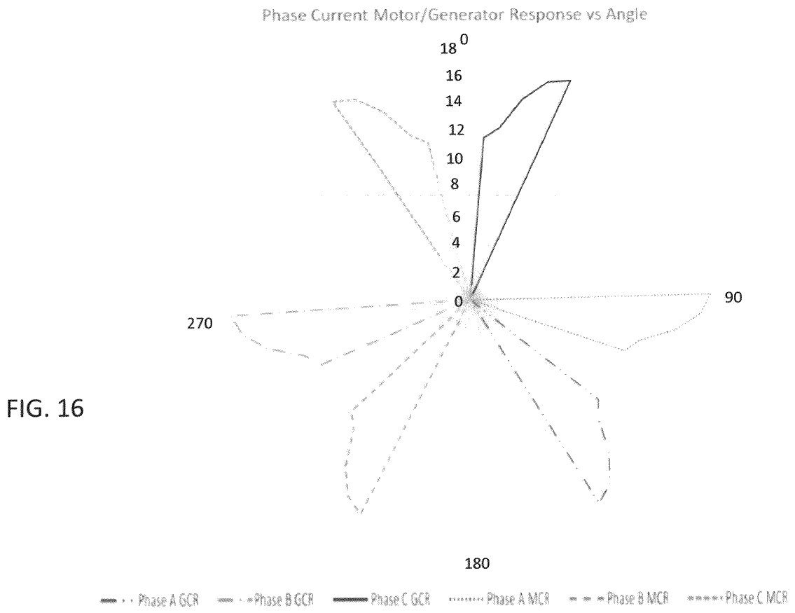

FIG. 16 is a graph illustrating an example embodiment of a relationship between angle and current response for Phase A (e.g., comprising a first pole pair 63f and 63c), Phase B (e.g., comprising a second pole pair 63b and 63e), and Phase C (e.g., comprising a third pole pair 63a and 63d), that occurs during a 360-degree rotation of the rotor of the AFSRM 51. The centerline for salient stator poles of Phase A are at 120 degrees, the centerline for salient stator poles for Phase B are at 240 degrees, and the centerline salient stator poles for Phase C are at 360 degrees. As a rotor lobe approaches 120, 240 and 360 degrees this is a motoring condition indicated by the current profile. FIG. 16 illustrates the motor current response (MCR) for each phase. As one rotor lobe passes 120, 240, and 360 degrees this is a generating condition indicated by the current profile. FIG. 16 also illustrates the generator current response (GCR) for each phase.

FIGS. 17A and 17B show a multi-physics analysis of dynamic operation in the AFSRM, to define magnetic flux density, according to an example embodiment. At time 0 seconds, shown in FIG. 17A, the flux density shows only one phase excited as shown by a pair of diametrically positioned bobbins in the stator 77. At time 0.05 seconds, shown in FIG. 17B, multiple phases experience current in the coils as indicated by the magnetic flux density plot on the right. In this particular example embodiment, the maximum value of 9.78 T is due to the local numerical issues on the edges of the rotor 73 and the stator 77. In some cases, the average magnetic flux density is in the range of 2 T, or is approximately 2 T.

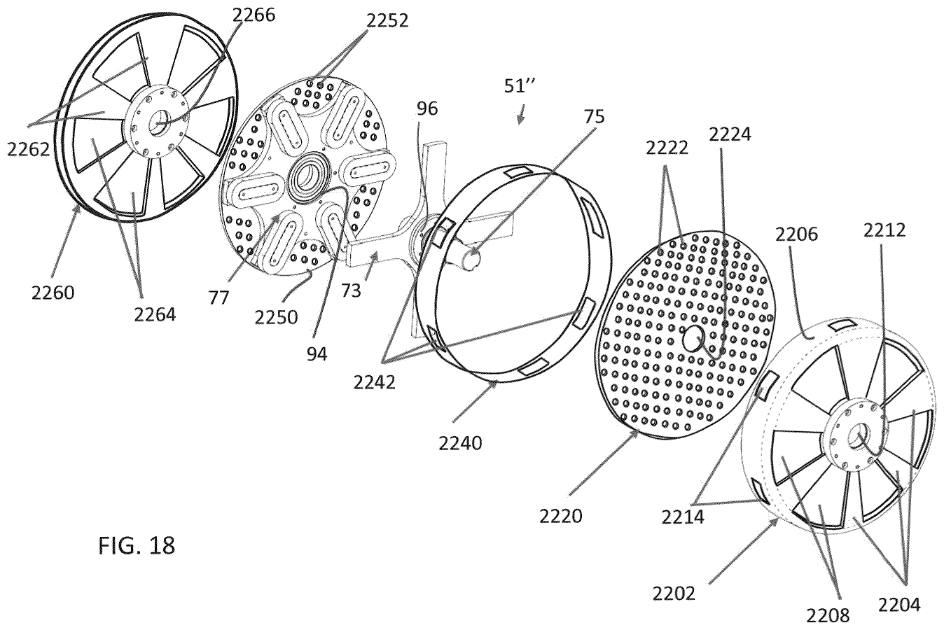

Turning to FIG. 18, another embodiment of an AFSRM 51″ is provided, shown in an exploded view. The AFSRM 51″ includes a housing that facilitates ventilation for cooling and provides electromagnetic shielding to reduce the effects of electromagnetic fields (EMF) produced by the AFSRM 51″. In some cases, EMF is also called electromagnetic frequencies, and/or radiofrequency electromagnetic fields.

Regarding the cooling, the housing includes holes that facilitate the flow of air for ventilation. In some cases, the coils in the AFSRM reach high temperatures, exceeding 100 degrees Celsius. In some cases, the AFSRM operating temperature of the coils exceeds 150 degrees Celsius. In some cases, the cooling by facilitating air ventilation by using holes in the housing helps dissipate heat from the coils.

Regarding the electromagnetic shielding, in some cases the AFSRM produces EMF that could adversely affect the operation and/or performance of other electronic devices in the nearby vicinity of the AFSRM. In some cases, including electromagnetic shielding, also herein called EMF shielding, reduces the effects of the EMF outputted by AFSRM. In some cases, this EMF shielding includes ventilation holes to facilitate heat dissipation from the coils.

In FIG. 18, the AFSRM 51″ includes a stator 77 that includes a front surface and an opposite facing rear surface, and a plurality of sidewalls that extend from the front surface to the rear surface. The stator further includes a plurality of salient stator poles positioned on the front surface. Each one of the plurality of salient stator poles includes: a bobbin protruding out from the front surface in a direction along an axis of the bobbin that is perpendicular to the front surface; the bobbin comprising a bobbin front surface that is substantially parallel to the front surface of the stator; and a coil of electrically insulated aluminum wire wound around the bobbin.

The AFSRM 51″ includes a rotor 73 comprising a front rotor surface and an opposite facing rear rotor surface, and further comprising a plurality of rotor poles. The rotor affixed to a shaft 75 and configured to rotate about an axis of rotation that is aligned with the shaft. In some cases, the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles.

In some cases, the AFRSRM 51″ further includes a housing with a circular profile. In some cases, the housing comprises a first major circular component 2220 and a second major circulator component 2250, and the stator 77 and the rotor 73 are positioned between the first major circular component 2220 and the second major circular component 2250, and at least each of the first major circular component 2220 and the second major circular component 2250 includes EMF shielding metal with ventilation holes 2222 and 2252.

In some cases, the first major circular component 2220 and the second major circulator component 2250 have a thin profile. In some cases, the first major circular component 2220 and the second major circulator component 2250 are formed from one or more sheets of metal. In some cases, the ventilation holes 2222 extend through the first major circular component 2220, and the ventilation holes 2252 extend through the second major circulator component 2250.

In some cases, the first major circular component 2220 has defined therein a grid of ventilation holes 2222. In some cases, the diameter of each of the ventilation holes 2222 is sized to reduce the effects of EMF. In some cases, the spacing between the ventilation holes 2222 is sized to reduce the effects of EMF. In some other cases, the ventilation holes 2222 are sized and spaced to improve ventilation. In some other cases, the ventilation holes 2222 are sized and shaped according to other criteria, and have different spacing, sizing and shape compared to the illustration shown in FIG. 22. In some cases, the second major circular component 2250 has defined therein a grid of ventilation holes 2252 that has the same or similar characteristics as the ventilation holes 2222.

In some cases, the second major circular component 2250 is a backing plate affixed the stator 77. A rotary bearing 94 is positioned at the center of the stator 77 and extends through the center of the second major circular component 2250. A portion of the shaft 75, which is coupled and affixed to the rotor 73, extends through the circular opening of the rotary bearing 94. In some cases, a flange 96 is used to help affix the shaft 75 to the rotor 73.

In some cases, the first major circular component 22020 and the second major circular component 2250 are each substantially parallel to a plane of rotation of the rotor 73.

In some cases, the housing further includes an outer chassis (2202 and 2260) that encapsulates the first major circular component 2220, the second major circular component 2250, the stator 77, and the rotor 73. In some cases, the outer chassis defines therein a first plurality of holes 2208 on a first major section 2204 that is facing the first major circular component 2220 and the first plurality of holes 2208 are aligned with at least a subset of the ventilation holes 2222 of the first major circular component 2220. This allows air to ventilate between the stator 77 and an environment external to the housing. In some cases, the outer chassis defines therein a second plurality of holes 2264 on a second major section 2262 that is facing the second major circular component 2250 and the second plurality of holes 2264 are aligned with at least a subset of the ventilation holes 2252 of the second major circular component 2250.

In some cases, the outer chassis is made from a different material than the EMF shielding metal of the first major circular component 2220 and the second major circular component 2250. In some cases, the outer chassis is a polymer. In some cases, the outer chassis comprises a 3D printed polymer component.

In some cases, the outer chassis comprises a plurality of components fixed together, including at least a first outer chassis component 2202, which includes the first major section 2204, and a second outer chassis component 2260, which includes the second major section 2262.

In some cases, the housing further comprises a circumferential metal EMF shield 2240 that circumferentially extends around the rotor 73 and the stator 77, and extends between the first major circular component 2220 and the second major circular component 2260. In some cases, the circumferential metal EMF shield 2240 defines therein a plurality of ventilation holes 2242.

In some cases, the circumferential metal EMF shield 2240, the first major circular component 2220 and the second major circular component 2260 are in contact with each other to allow electrons to flow therebetween. In some cases, the circumferential metal EMF shield 2240, the first major circular component 2220 and the second major circular component 2260 form an EMF shield around the rotor 73 and the stator 77.

In some cases, the outer chassis includes an outer circumferential portion 2206 that circumferentially extends around the circumferential metal EMF shield 2240. In some cases, the outer circumferential portion 2206 defines therein a plurality of outer ventilation holes 2214 that are aligned with the plurality of ventilation holes 2242 defined in the circumferential metal EMF shield 2240. In some cases, this configuration facilitates a stronger chassis, while providing EMF shielding and ventilation.

In some cases, the shaft 75 passes through a hole 2224 defined in the center of the first major circular component 2220, and through a hole 2212 defined in the center of the first outer chassis component 2202. In some cases, another end of the shaft 75 passes through a hole 2266 defined in the center of the second outer chassis component 2260.

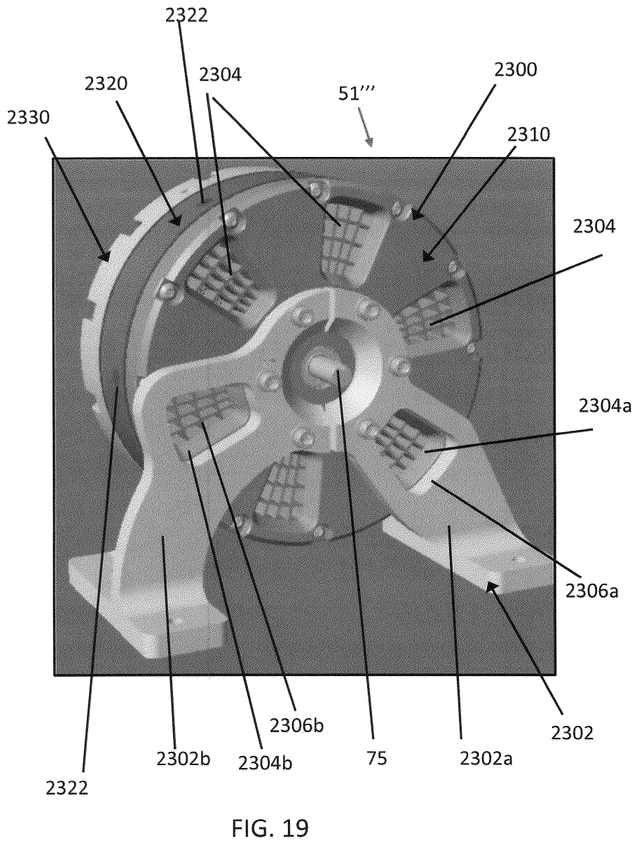

Turning to FIG. 19, another variant of the AFSRM 51′″ is shown that is similar to the AFSRM 51″ shown in FIG. 18. The AFSRM 51′″ include the stator 77 and rotor 73, as well as an EMF shielding formed by one or a combination of: the circumferential metal EMF shield 2240, the first major circular component 2220 and the second major circular component 2260. In some cases, the combination of the circumferential metal EMF shield 2240, the first major circular component 2220 and the second major circular component 2260 form an EMF shield around the rotor 73 and the stator 77.

In FIG. 19, an outer chassis 2300 of the housing is formed from a first outer chassis component 2310, an intermediate outer chassis component 2320, and a second outer chassis component 2330. In the illustration of FIG. 19, a subset of the plurality of ventilation holes 2222 of the first major circular component 2220 is aligned with a first plurality of holes 2304 defined in the first outer chassis component 2310. In some cases, the plurality of ventilation holes 2242 in the circumferential EMF shield 2240 are aligned with a plurality of outer ventilation holes 2322 defined in the intermediate outer chassis component 2320.

In some cases, a mounting bracket 2302 is attached to a first outer chassis component 2310. In some other cases, the mounting bracket 2302 is attached to one or a combination of the first outer chassis component 2310, the intermediate outer chassis component 2320, and the second outer chassis component 2330. In some cases, the mounting bracket 2302 is formed from multiple pieces, including a first mounting bracket component 2302a and a second mounting bracket component 2302b.

In some cases, the mounting bracket 2302 defines therein one or more bracket holes 2306a, 2306b that are aligned with at least a subset of the ventilation holes 2304a, 2304b of the first major circular component or at least a subset of the ventilation holes first plurality of holes 2304 defined in the first outer chassis component 2310. In some cases, the mounting bracket defines therein one or more bracket holes that are each aligned with at least a subset of the ventilation holes 2222 of the first major circular component 2220 or at least a subset of the ventilation holes 2252 of the second major circular component 2250. The bracket holes 2306a, 2306b facilitate ventilation of the stator 77 and rotor 73.

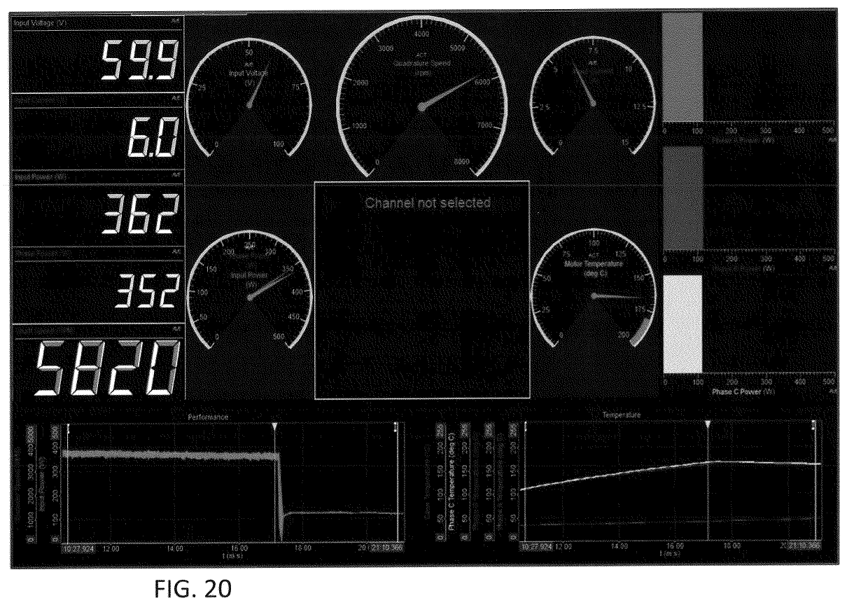

Turning to FIG. 20, a screenshot showing operational parameters of an AFSRM is provided according to an example embodiment. The AFSRM is inputted with approximately 59.9 V and approximately 6.0 A, producing approximately an input power of 362 W. The shaft speed of the AFSRM is approximately 5820 RPM. The AFSRM temperature, which can be measured at one or more coils, is approximately 167 degrees Celsius.

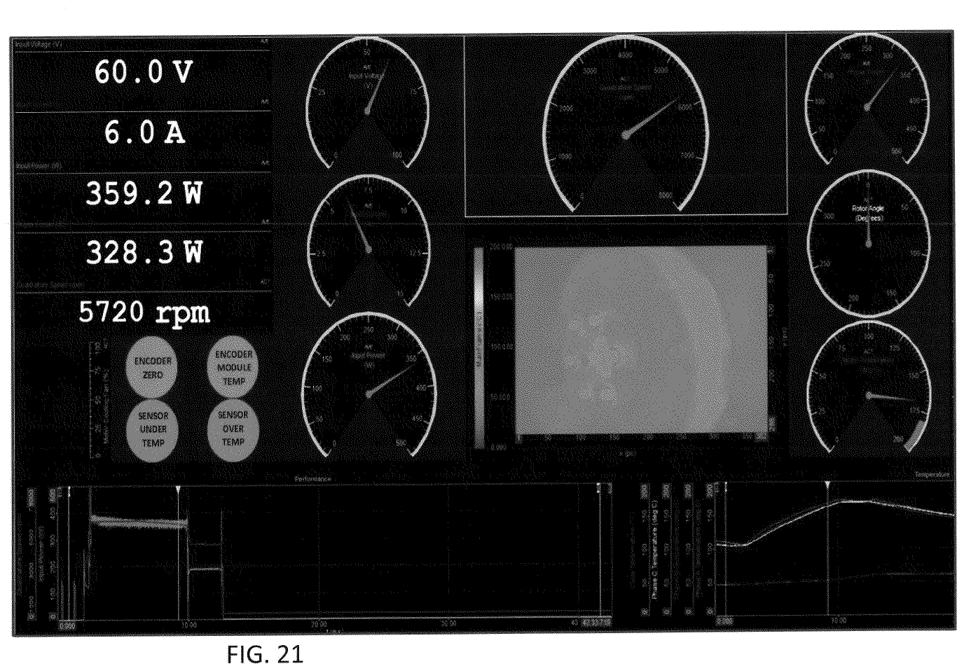

Turning to FIG. 21, a screenshot showing operational parameters of an AFSRM is provided according to another example embodiment. The AFSRM is inputted with approximately 60.0 V and approximately 6.0 A, producing approximately an input power of 359.2 W. The shaft speed of the AFSRM is approximately 5720 RPM. The AFSRM temperature, which can be measured at one or more coils, is approximately 168 degrees Celsius.

Turning to FIG. 22, a screenshot showing operational parameters of an AFSRM is provided according to another example embodiment. The AFSRM is inputted with approximately 106.0 V and approximately 6.7 A, producing approximately an input power of 711 W. The shaft speed of the AFSRM is approximately 8116 RPM. The AFSRM temperature, which can be measured at one or more coils, is approximately 181 degrees Celsius.

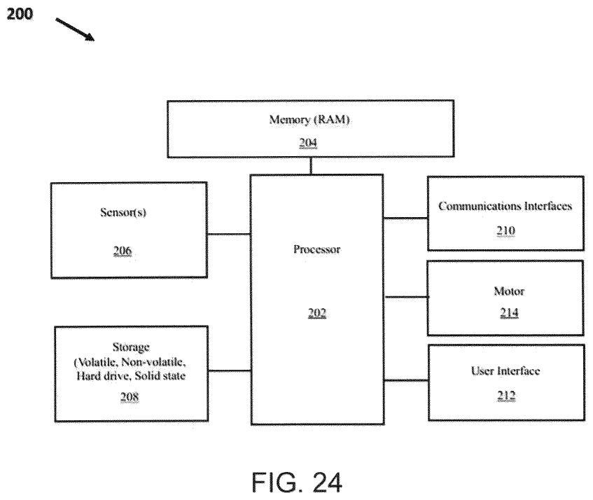

FIG. 23 is a block diagram of an axial flux switched reluctance motor/generator system 100. The axial flux switched reluctance motor/generator system 100 includes a controller 102. The controller 102 may include a processor and/or computer system 110. The system 100 may also include a power source 1 and/or storage 108 which may, for example, include one or more batteries capable to receiving and storing electrical energy when the axial flux switched reluctance motor-generator 104 operates as a generator or outputting torque power when the axial flux switched reluctance motor-generator 104 operates as a motor. The system 100 may include one or more sensors 106 configured to sensor one or more conditions associated with the motor-generator 104 such as, without limitation, the motor-generator 104 rotor assembly speed of rotation, the motor-generator 104 rotor assembly angular position, the motor-generator 104 temperature, the motor-generator 104 output or input current, and/or the motor-generator 104 voltage. The controller 102 may utilize a processor 110 to receive sensor data from the one or more sensors 106 and, based on the sensor data, control one or more operations of motor-generator 104. Further details regarding processor 110 are described with respect to FIG. 24.

The axial flux switched reluctance motor/generator system 100 may include a stator assembly arranged to generate a rotating electromagnetic field in response to a control signal from the controller 102. The system 100 may also include a rotor assembly, positioned adjacent to the stator assembly, arranged to rotate in response to the rotating electromagnetic field. One or more sensors 106 can be arranged to detect an angular position of the rotor assembly and output sensor data based on the angular position of the rotor assembly, among other conditions of motor-generator 104. The controller 102 can be arranged to receive the sensor data and adjust the control signal based on the angular position of the rotor assembly to adjust a torque associated with the rotor assembly when the system 100 functions as a motor or to adjust a power output from the stator assembly when the system 100 functions as a generator. The one or more sensors may be arranged to detect one or more additional axial flux switched reluctance motor/generator system 100 conditions including, for example, a rotor assembly speed, stator current, stator voltage, and state machine temperature. The controller 102 may be configured to adjust the control signal to, thereby, adjust an operation of axial flux switched reluctance motor-generator 104, based on the sensor data associated with multiple detected conditions of the motor-generator 104.

System 100 and various implementations of rotor-stator configurations eliminate the need for rare Earth magnets and copper conductors in, for example, an axial flux switched reluctance motor-generator 104. However, in some other cases, rare Earth magnets and/or copper conductors can still be utilized to amplify the performance of an the axial flux switched reluctance motor-generator 104. In some cases, a differentiation of motor-generator 104 with respect to conventional systems includes leveraging reluctance to generate torque or electrical power. The system, devices, and methods described herein include electromagnets suitable for integration into electric motors and/or generators which have flux characteristics comparable to rare Earth magnets. In some cases, a magnetic circuit is provided which includes the electromagnets integrated into the salient stator poles, and the electromagnets utilize low cost and readily available steel alloys. Examples of steel alloys include, without limitation, stainless steel, duplex stainless steel, maraging steel, carbon steel Vanadium, high-speed steel, Titanium, Forromolybdenum, HSLA steel, Alloy 20, Ferromanganese, Ferronickel, chrome steel, Chromium-vanadium steel, electrical steel, Damascus steel, AL-6XN, Spring steel Bulat steel, ANSI 4145, Microalloyed steel, and Molybdenum. The aforementioned components can be configured and oriented in such a way to improve the flux path for each phase resulting in reduced power consumption and increased torque. In some cases, the heat generation of, for example, the axial flux switched reluctance motor-generator 104 has been significantly improved due to the geometric construction of the electromagnets. In some cases, the method of electrical excitation also helps control the heat generation.

FIG. 24 shows a diagram of a processor and/or computer system 200 that may be implemented in, for example, a controller 102. The processor system 200 could represent a processing system within a motor and/or generator controller such as described in FIG. 24, e.g., processor 110 of the controller 102. Processor and/or computer system 200 may include a microcontroller, a processor, a system-on-a-chip (SoC), a client device, and/or a physical computing device and may include hardware and/or virtual processor(s). In some implementations, processor system 200 and its elements as shown in FIG. 24 each relate to physical hardware and in some implementations one, more, or all of the elements could be implemented using emulators or virtual machines. Regardless, processor system 200 may be implemented on physical hardware.

As also shown in FIG. 24, processor system 200 may include a user interface 212, having, for example, a keyboard, keypad, touchpad, or sensor readout (e.g., biometric scanner) and one or more output devices, such as displays, speakers for audio, LED indicators, and/or light indicators. Processor and/or computer system 200 may also include communications interfaces 210, such as a network communication unit that could include a wired communication component and/or a wireless communications component, which may be communicatively coupled to one or more components of controller 102. The network communication unit may utilize any of a variety of proprietary or standardized network protocols, such as Ethernet, TCP/IP, to name a few of many protocols, to effect communications between processor 202 and another device, network, or system. Network communication units may also comprise one or more transceivers that utilize the Ethernet, power line communication (PLC), Wi-Fi, cellular, and/or other communication methods.

Processor and/or computer system 200 may include a processing element, such as controller and/or processor 202, that contains one or more hardware processors, where each hardware processor may have a single or multiple processor cores. In one implementation, the processor 202 includes at least one shared cache that stores data (e.g., computing instructions) that are utilized by one or more other components of processor 202. For example, the shared cache may be a locally cached data stored in a memory for faster access by components of the processing elements that make up processor 202. Examples of processors include, but are not limited to a central processing unit (CPU) and/or microprocessor. Controller and/or processor 202 may utilize a computer architecture base on, without limitation, the Intel® 8051 architecture, Motorola® 68HCX, Intel® 80X86, and the like. Processor 202 may include, without limitation, an 8-bit, 12-bit, 16-bit, 32-bit, or 64-bit architecture. Although not illustrated in FIG. 16, the processing elements that make up processor 202 may also include one or more other types of hardware processing components, such as graphics processing units (GPUs), application specific integrated circuits (ASICs), field-programmable gate arrays (FPGAs), and/or digital signal processors (DSPs). It may include an ASIC designed to run adaptive AI at the edge such as Google Edge TPU (Tensor Processing Unit) or other ASICs for deep learning, training, and inference, to optimize performance.

FIG. 24 illustrates that memory 204 may be operatively and communicatively coupled to processor 202. Memory 204 may be a non-transitory medium configured to store various types of data. For example, memory 204 may include one or more storage devices 208 that include a non-volatile storage device and/or volatile memory. Volatile memory, such as random-access memory (RAM), can be any suitable non-permanent storage device. The non-volatile storage devices 208 may include one or more disk drives, optical drives, solid-state drives (SSDs), tape drives, flash memory, read-only memory (ROM), and/or any other type memory designed to maintain data for a duration time after a power loss or shut down operation. In certain configurations, the non-volatile storage devices 208 may be used to store overflow data if allocated RAM is not large enough to hold all working data. The non-volatile storage devices 208 may also be used to store programs that are loaded into the RAM when such programs are selected for execution. Data store and/or storage devices 208 may be arranged to store a plurality of motor control instruction programs associated with operating a motor. Such control instruction programs may include instruction for controller and/or processor 202 to: run, adjust speed, start or stop one or more motors 104 and/or 214 (e.g., a drive motor for an electric vehicle). The motor 104 and/or 214 refer to the embodiments of the AFSRM described in this application.

Persons of ordinary skill in the art are aware that software programs may be developed, encoded, and compiled in a variety of computing languages for a variety of software platforms and/or operating systems and subsequently loaded and executed by processor 202. In some cases, the compiling process of the software program may transform program code written in a programming language to another computer language such that the processor 202 is able to execute the programming code. For example, the compiling process of the software program may generate an executable program that provides encoded instructions (e.g., machine code instructions) for processor 202 to accomplish specific, non-generic, particular computing functions.

In some cases, after the compiling process, the encoded instructions are loaded as computer executable instructions or process steps to processor 202 from storage 208, from memory 204, and/or embedded within processor 202 (e.g., via a cache or on-board ROM). Processor 202 may be configured to execute the stored instructions or process steps in order to perform instructions or process steps to transform the processor and/or computer system 200 into a non-generic, particular, specially programmed machine or apparatus. Stored data, e.g., data stored by a data store and/or storage device 208, may be accessed by processor 202 during the execution of computer executable instructions or process steps to instruct one or more components within processor system 200 and/or other components or devices external to system 200.

In some cases, a user interface 212 includes a display, positional input device (such as a mouse, touchpad, touchscreen, or the like), keyboard, keypad, one or more buttons, or other forms of user input and output devices. The user interface components may be communicatively coupled to processor 202. When the user interface output device is or includes a display, the display can be implemented in various ways, including by a liquid crystal display (LCD) or a cathode-ray tube (CRT) or light emitting diode (LED) display, such as an OLED display. Sensors 206 may include one or more sensors that detect and/or monitor conditions within or surrounding system 200 and/or within or surrounding a motor such as motor 104 and/or 214. Conditions may include, without limitation, rotation, speed of rotation, and/or movement of a device or component (e.g., a motor), temperature, pressure, current, position of a device or component (e.g., angular position of a rotor). Persons of ordinary skill in the art are aware that electronic processing systems, such as system 200, may include other components well known in the art, such as power sources, e.g., power source 108, and/or analog-to-digital converters, not explicitly shown in FIG. 24.

In some cases, processor and/or computer system 200 and/or processor 202 includes an SoC having multiple hardware components, including but not limited to:
a microcontroller, microprocessor or digital signal processor (DSP) core and/or multiprocessor SoCs (MPSoC) having more than one processor cores;
memory blocks including a selection of read-only memory (ROM), random access memory (RAM), electronically erasable programmable read-only memory (EEPROM) and flash memory;
timing sources including oscillators and phase-docked loops;
peripherals including counter-timers, real-time timers and power-on reset generators;
external interfaces, including industry standards such as universal serial bus (USB), FireWire, Ethernet, universal synchronous/asynchronous receiver/transmitter (USART), serial peripheral interface (SPI);
analog interfaces including analog-to-digital converters (ADCs) and digital-to-analog converters (DACs); and
voltage regulators and power management circuits.

In some cases, a SoC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

In some cases, after the overall architecture of the SoC has been defined, individual hardware elements may be described in an abstract language called RTL which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some implementations, various components of processor system 200 are implemented on a printed circuit board (PCB).

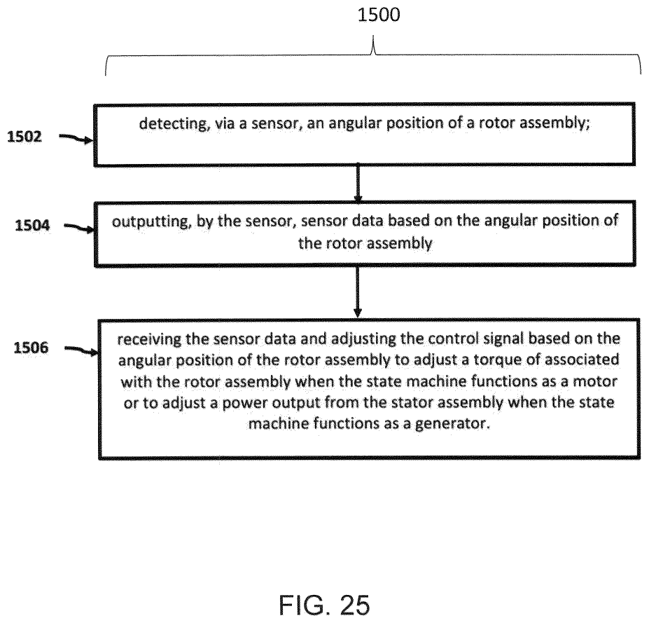

FIG. 25 shows a process 1500 for operating a reluctance motor. The process 1500 includes detecting, via a sensor such as sensor 106, an angular position of a rotor assembly such as, for example, rotor assembly 504 or 1204 (Step 1502). Outputting, by sensor 106, sensor data based on the angular position of the rotor assembly 504 or 1204 (Step 1504). Then, receiving the sensor data by a controller such as controller 102 and adjusting a control signal based on the angular position of the rotor assembly 504 or 1204 to adjust a torque of associated with the rotor assembly 504 or 1204 when the state machine 500 or 1200 functions as a motor or to adjust a power output from the stator assembly when the state machine functions as a generator (Step 1506).

It will be appreciated that the motor devices described herein can also be used as generators to generate electric power.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 63a, 63b, 63c, etc.). All elements with a common base number may be referred to collectively or generically using the base number without a suffix (e.g., 63).

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. An axial flux switched reluctance motor, comprising
a stator comprising a front surface and an opposite facing rear surface, and a plurality of sidewalls that extend from the front surface to the rear surface;
the stator further comprising a plurality of salient stator poles positioned on the front surface, each one of the plurality of salient stator poles comprising:
a bobbin protruding out from the front surface in a direction along an axis of the bobbin that is perpendicular to the front surface;
the bobbin comprising a bobbin front surface that is substantially parallel to the front surface of the stator;
a coil of electrically insulated aluminum wire wound around the bobbin;
a rotor comprising a front rotor surface and an opposite facing rear rotor surface, and further comprising a plurality of rotor poles;
the rotor affixed to a shaft and configured to rotate about an axis of rotation that is aligned with the shaft;
wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles; and
wherein the axial flux switched reluctance motor operates with a temperature of the coil of at least 150 degrees Celsius and a shaft speed of over 5000 Rotations Per Minute (RPM).

2. The axial flux switched reluctance motor of claim 1, wherein the coil of electrically insulated aluminum wire wound around the bobbin is encapsulated in an encapsulation compound that has an operating temperature of over 150 degrees Celsius.

3. The axial flux switched reluctance motor of claim 2, wherein the operating temperature of the encapsulation compound is over 200 degrees Celsius.

4. The axial flux switched reluctance motor of claim 3, wherein the operating temperature of the encapsulation compound is over 250 degrees Celsius.

5. The axial flux switched reluctance motor of claim 1, wherein an input power of over 700 Watts is provided to the axial flux switched reluctance motor, and the shaft speed is at least 8000 RPM.

6. The axial flux switched reluctance motor of claim 1, wherein an input voltage of 106 Volts, an input current of 6.7 Amps, and an input power of 711 Watts is provided to the axial flux switched reluctance motor; and the shaft speed is over 8100 RPM and the temperature of the coil is at least 180 degrees Celsius.

7. The axial flux switched reluctance motor of claim 1, wherein an input voltage of over 59 Volts is provided to the axial flux switched reluctance motor.

8. The axial flux switched reluctance motor of claim 1, wherein an input voltage of between 59 and 61 Volts is provided to the axial flux switched reluctance motor, and the axial flux switched reluctance motor operates at the shaft speed of over 5700 RPM.

9. The axial flux switched reluctance motor of claim 1, further comprising a housing that includes an electromagnetic field (EMF) metal shield that encompasses the stator and the rotor, and the EMF metal shield has defined therein a plurality of ventilation holes.

10. An axial flux switched reluctance motor, comprising
a stator comprising a front surface and an opposite facing rear surface, and a plurality of sidewalls that extend from the front surface to the rear surface;
the stator further comprising a plurality of salient stator poles positioned on the front surface, each one of the plurality of salient stator poles comprising:
a bobbin protruding out from the front surface in a direction along an axis of the bobbin that is perpendicular to the front surface;
the bobbin comprising a bobbin front surface that is substantially parallel to the front surface of the stator;
a coil of electrically insulated wire wound around the bobbin;
a rotor comprising a front rotor surface and an opposite facing rear rotor surface, and further comprising a plurality of rotor poles;
the rotor affixed to a shaft and configured to rotate about an axis of rotation that is aligned with the shaft;
wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles; and
a housing that comprises a first major circular component and a second major circulator component, and the stator and the rotor are positioned between the first major circular component and the second major circular component, and the first major circular component and the second major circular component each comprise electromagnetic field (EMF) shielding metal that has defined therein a plurality of ventilation holes.

11. The axial flux switched reluctance motor of claim 10, wherein the first major circular component and the second major circular component are each substantially parallel to a plane of rotation of the rotor.

12. The axial flux switched reluctance motor of claim 10, wherein the housing further comprises an outer chassis that encapsulates the first major circular component, the second major circular component, the stator, and the rotor; and the outer chassis defines therein a first plurality of holes on a first major section that is facing the first major circular component and the first plurality of holes are aligned with at least a subset of the plurality of ventilation holes defined in the first major circular component.

13. The axial flux switched reluctance motor of claim 12, wherein the outer chassis defines therein a second plurality of holes on a second major section that is facing the second major circular component and the second plurality of holes are aligned with at least another subset of the ventilation holes defined in the second major circular component.

14. The axial flux switched reluctance motor of claim 12, wherein the outer chassis is made from a different material than the EMF shielding metal.

15. The axial flux switched reluctance motor of claim 14, wherein the outer chassis is made is a polymer.

16. The axial flux switched reluctance motor of claim 13, wherein the outer chassis comprises a plurality of components fixed together, including at least a first outer chassis component comprising the first major section and a second outer chassis component comprising the second major section.

17. The axial flux switched reluctance motor of claim 13, further comprising a mounting bracket attached to the first major section or the second major section, or both, and the mounting bracket defining therein a bracket hole that is aligned with at least a subset of the plurality of ventilation holes defined in the first major circular component or at least a subset of the plurality of ventilation holes defined in the second major circular component.

18. The axial flux switched reluctance motor of claim 10, wherein the housing further comprises a circumferential metal EMF shield that circumferentially extends around the rotor and the stator, and extends between the first major circular component and the second major circular component, wherein the circumferential metal EMF shield defines a plurality of ventilation holes.

19. The axial flux switched reluctance motor of claim 18, wherein the housing further comprises an outer chassis, and the outer chassis comprises an outer circumferential portion that circumferentially extends around the circumferential metal EMF shield; and, the outer circumferential portion defining therein a plurality of outer ventilation holes that are aligned with the plurality of ventilation holes defined in the circumferential metal EMF shield.

20. The axial flux switched reluctance motor of claim 10, wherein the axial flux switched reluctance motor operates with a temperature of the coil of at least 150 degrees Celsius and a shaft speed of over 5000 Rotations Per Minute (RPM).

21. The axial flux switched reluctance motor of claim 10, wherein an input power of over 700 Watts is provided to the axial flux switched reluctance motor, and a shaft speed is over 8000 RPM.

22. The axial flux switched reluctance motor of claim 21, wherein the temperature of the coil is over 180 degrees Celsius.

23. An axial flux switched reluctance motor, comprising
a stator comprising a front surface and an opposite facing rear surface, and a plurality of sidewalls that extend from the front surface to the rear surface;
the stator further comprising a plurality of salient stator poles positioned on the front surface, each one of the plurality of salient stator poles comprising:
a bobbin protruding out from the front surface in a direction along an axis of the bobbin that is perpendicular to the front surface;
the bobbin comprising a bobbin front surface that is substantially parallel to the front surface of the stator;
a coil of electrically insulated aluminum wire wound around the bobbin;
a rotor comprising a front rotor surface and an opposite facing rear rotor surface, and further comprising a plurality of rotor poles;
the rotor affixed to a shaft and configured to rotate about an axis of rotation that is aligned with the shaft;
wherein the rear rotor surface of each of the plurality of rotor poles is spaced apart from the bobbin front surface of each of the plurality of salient stator poles, to facilitate the rear rotor surface to rotate over the bobbin front surface and for magnetic flux to flow between the bobbin front surface of each of the plurality of salient stator poles and the rear rotor surface of each of the plurality of rotor poles;
a housing that comprises a first major circular component and a second major circulator component, and the stator and the rotor are positioned between the first major circular component and the second major circular component, and the first major circular component and the second major circular component each comprise electromagnetic field (EMF) shielding metal that has defined therein a plurality of ventilation holes;
wherein the first major circular component and the second major circular component are each substantially parallel to a plane of rotation of the rotor;
the housing further comprises an outer chassis that encapsulates the first major circular component, the second major circular component, the stator, and the rotor;
the outer chassis defines therein a first plurality of holes on a first major section that is facing the first major circular component and the first plurality of holes are aligned with at least a subset of the plurality of ventilation holes defined in the first major circular component;
the housing further comprises a circumferential metal EMF shield that circumferentially extends around the rotor and the stator, and extends between the first major circular component and the second major circular component, wherein the circumferential metal EMF shield defines therein an additional plurality of ventilation holes;
the outer chassis comprises an outer circumferential portion that circumferentially extends around the circumferential metal EMF shield, and, the outer circumferential portion defining therein a plurality of outer ventilation holes that are aligned with the plurality of additional ventilation holes defined in the circumferential metal EMF shield; and
wherein the axial flux switched reluctance motor operates with a temperature of the coil of at least 150 degrees Celsius and a shaft speed of over 5000 Rotations Per Minute (RPM).
